(19) United States
(12) Patent Application Publication
(10) Pub. No.: US 2005/0232574 A1
(43) Pub. Date: Oct. 20, 2005

(54) VIDEO GENERATION DEVICE, VIDEO GENERATION METHOD, AND VIDEO STORAGE DEVICE

(76) Inventor: Fumi Kawai, Tokyo (JP)

Correspondence Address: PEARNE & GORDON LLP, 1801 EAST 9TH STREET, SUITE 1200, CLEVELAND, OH, 44114-3108, US

(21) Appl. No.: 10/519,956

(22) PCT Filed: Jul. 2, 2003
(86) PCT No.: PCT/JP03/08424

§ 371 Date: Apr. 15, 2005

(30) Foreign Application Priority Data
Jul. 2, 2002 (JP) 2002-193048

(51) Int. Cl. H04N 5/91

(52) U.S. Cl. 386/46

(57) ABSTRACT

A video generation processing apparatus for generating a multi-angle video consisting of a base video and a related video that relates to the base video is obtained. A video database 105 in which video data and imaging position information as attribute information of respective video data are recorded is provided. When the user inputs a searching key by using displaying means 101, related-video condition generating means 103 acquires a video that meets the search key from the video database 105 and then decides related video conditions of the video based on information of the acquired video. Video searching/synthesizing means 104 generates a multi-angle video by synthesizing a video that meets the search key being input from the displaying means 101 and a video that meets the video conditions generated by the related-video condition generating means 103. Accordingly, the perusing of the monitoring video that can enhance a crime preventing effect and the user interface can be implemented.

### TECHNICAL FIELD

The present invention relates to a video generation processing apparatus, a video generation processing method, and a video storing apparatus used in the monitor video that is practicable for the purpose of enhancing the crime preventing effect and implementing the monitoring at a higher security level. The video generation processing apparatus and the video generation processing method capable of realizing a search for the video that meets the desired conditions as well as the video related to it. Also, the video storing apparatus has a data management structure to improve efficiency of the search executed based on attribute information that the video data possess.

### BACKGROUND ART

Crimes such as burglary, murder and injury, and the like are increasing steadily year by year at the present day. In particular, crimes are increasing rapidly in recent years in the public facilities such as post office, school, station, road, etc. Thus, interest in the monitoring security is mounting rapidly among the common run of people.

The monitoring using the monitor camera has mainly two functions. One function is to check by the live video whether or not anything unusual occurred in the existing state. According to this, the abnormal situation can be dealt with quickly even when such situation occurred, and thus such situation can be suppressed to the minimum damage. Also, the fact that the area is monitored can produce such an effect that a crime preventing effect is enhanced.

The second function is that the accumulated video recorded on the video tape recorder, the hard disk drive, or the like is played and checked at a later date when the live monitoring is not applied, otherwise circumstances before and after the event are checked or the video that recorded the event is analyzed even when the event, or the like occurred. In particular, many facilities are not equipped with the live monitoring in Japan. Thus, for example, the video is fast-forwarded on the next day to check whether or not the abnormality has occurred, or the video is referred to in many uses when the event occurred. In this case, the recorded video is sometimes afforded to the police office in analyzing the event or checking the circumstances, and is utilized as the material to arrest the criminal or the measure to prevent previously the event.

The monitoring system to embody such monitoring is mainly constructed by a plurality of monitor cameras, the video recording equipment, the displaying means for playing the video, and the transfer medium for transferring the video between the monitor cameras and the video recording equipment and between the video recording equipment and the video displaying means.

As the technical trend associated with them, it is noteworthy nowadays that the spread of the large-capacity high-speed communication, the larger capacity of the recording medium, and the practical use of the digital technology are proceeding.

A data transmission efficiency in the large-capacity high-speed communication is improved with the progress of the digital compression technology such as JPEG (Joint Photographic Experts Group), MPEG (Moving Picture Experts Group), etc., and also the large-capacity high-speed communication is diffused to the private level through the spread of the communication medium or communication method such as FTTH (Fiber To The Home), ADSL (Asymmetric Digital Subscriber Line), etc. As a result, video data are transmitted from a plurality of monitoring locations to a remote monitoring center, or the like and accumulated/managed therein, and also the supervisor can view freely the monitor video from his or her own home, or the like via the Internet.

Also, the larger capacity in the recording capacity is advancing owing to the lower cost of the recording medium and the spread of the digital recording apparatus into the hard disk, etc. In the digital recording apparatus, the accumulated video can be played not to stop the recording operation and the video can be accumulated while being correlated with the data of the sensor, or the like.

According to the above progress of the technology, the system that can manage the videos picked up at a plurality of monitoring spots collectively from a remote location or accumulate a large volume of video is spread, and also free view of the video via the Internet can be implemented.

As a result, anyone can read the accumulated video at any time from any place. In contrast, problems that confront the monitoring person are caused such that sufficient knowledge about the monitoring situation in the monitoring spot is required to find a desired video, a labor is increased to find the desired video from a large volume of video, and so on.

Therefore, in order to put sufficiently functions of the above large-capacity and multi-spot accessible monitoring system to practical use, it is important to utilize the video searching/reading system that can search a desired video more easily and more effectively from a large volume of accumulated video and can read such large volume of accumulated video more effectively.

As the video searching/reading apparatus up to now, the apparatus set forth in JP-A-10-243380 and JP-A-11-282851 are known. Normally such apparatus is constructed to have a configuration shown in FIG. 19, and the data flow takes often a flow shown in FIG. 19.

The video searching/reading apparatus in the related art will be explained with reference to FIG. 19 hereunder. The video searching/reading apparatus is constructed three means, i.e., displaying means shown in 1901 and having a function of inputting the searching conditions and a function of displaying video data, video searching means shown in 1902 and having a function of searching the adapted video from a video database based on the searching conditions input by the displaying means and a function of outputting text information or video data obtained as the searched result to the displaying means, and a video database shown in 1903 and having a function of accumulating the video data and attribute information of the video data if necessary.

Next, an operation thereof will be explained hereunder. In the case where the user wants to get the video picked up at a particular time, the video picked up by a particular camera, or the video showing a particular spot, such user enters data as the searching conditions into the displaying means 1901 to instruct it to search such video. The displaying means 1901, when received the instruction, sends out input searching conditions 1904 to the video searching means 1902. The video searching means 1902 searches the video that meets the conditions from video data accumulated in the video database 1903, based on searching conditions 1905. The video search is applied to all the accumulated video data, and then searched result data 1906 consisting of adapted video data or IDs indicating uniquely the video data is formed. The video searching means 1902 sends out searched result data 1907 to the displaying means 1901, and then the displaying means 1901 shows the data to the user.

As indicated by the approach in the related art, normally the accumulated video searching apparatus searches the video that meets the conditions, based on the search keys such as the camera ID input by the user, position information, time information, etc.

In this case, since the object is not shown at a desired angle in the video that has been obtained by the conditional search (referred to as a “noticeable video” hereinafter), the accumulated videos must be often searched once again to detect the videos that are shot from different angles. For example, in the case where the doubtful person or object is found in the noticeable video, such a request that “the user wants to watch the video that is picked up at a different angle” is frequently made. However, in the video searching/reading apparatus in the related art, the desired video must be searched newly by setting the conditions once again in such a way that other cameras that seems to shoot the same spot are searched, or the like, and thus it takes much time to get the desired video.

Also, upon reading the monitor video, the user has a demand for checking the surrounding circumstances of the spot that is shown in the noticeable video. However, in the video searching/reading apparatus in the related art, the user must grasp which camera shows the surrounding spots and search the video that shows the desired position, and thus it takes much time to get the desired video. Also, since the knowledge of the monitoring situation concerning which camera picked up which place at that time and the knowledge of the monitoring spot are required of the user, such a problem exists that it is only the person having these knowledge that can view easily the desired video.

Also, the dead angle formed by physical substances such as the shelf, the pillar, and the like is present in the monitored spot. However, in the video searching/reading apparatus in the related art, in order to check whether or not anything unusual happened in the dead angle area in the noticeable video, the user must grasp which camera shows that spot and then search newly the desired video, and thus it takes long time to get the desired video. Also, since the knowledge concerning which area constituted the dead angle area in the monitored video and the knowledge concerning which camera showed the dead angel area are required of the user, such a problem exists that it is only the person having these knowledge that can view easily the desired video.

Also, in the case where plural adapted videos are found by the conditional search or a plurality of videos are checked simultaneously on the multiple screens, it is difficult to find the most desirable video among these videos according to an amount of them and thus the user is forced to bear a burden.

Also, upon perusing the video to be watched mainly and its associated video, the video to be watched mainly is often changed. In the video searching/reading apparatus in the related art, since the videos that are related to the main video must be set manually to monitor these videos, the related video must be searched once again correspondingly when the noticeable video is changed. This search requires a great deal of working labor.

Also, in the monitoring apparatus in the related art, in many cases a recording area in which the desired video of the monitor can be saved is provided to the different area separated from the normal recording area in which the videos picked up by the monitor camera are recorded. However, in the monitoring apparatus in the related art, since such an arrangement is employed that the still picture or the moving picture is saved individually, the working labor becomes considerable when a large number of images to be saved are present. Also, in picking up these saved videos, much time and labor are needed to collect all the videos that meet the desired conditions.

Also, in the video searching/reading apparatus in the related art, such a format is employed that the video data are saved in unit of camera. Therefore, in searching the video while using each attribute information value of the video data as the search key, the video having the adapted attribute value must be searched from the video data of all cameras. As a result, a huge searching time is required.

### DISCLOSURE OF THE INVENTION

The present invention has been made to overcome the above problems, and it is an object of the present invention to provide a video generation processing apparatus and a video generation processing method capable of selecting automatically video data serving as a basis and the video having a great deal of relevance to the video data and also handling integrally these plural videos. Also, it is another object of the present invention to provide a video storing apparatus capable of searching quickly a desired video.

A video generation processing apparatus of the present invention for processing a plurality of videos, which are related with each other to satisfy predetermined conditions, among videos picked up by a plurality of imaging apparatus to display, comprises imaging position information acquiring means for acquiring imaging position information of a base video that meets first predetermined conditions from video storing means for storing the videos picked up by the plurality of imaging apparatus and additional information of respective videos; related-video condition generating means for generating related-video conditions based on the acquired imaging position information and data/hour information contained in the first predetermined conditions; and video acquiring means for acquiring a related video that meets the related-video conditions from the video storing means. Therefore, the video in monitoring and the video having the high relevancy with the video can be handled integrally.

Also, preferably the video generation processing apparatus of the present invention further comprises display processing means for processing the base video and the related video to display simultaneously on one screen. Therefore, the desired object can be monitored as the multi-angle video.

Also, in the video generation processing apparatus of the present invention, preferably an imaging apparatus for picking up the related video and an imaging apparatus for picking up the base video are different respectively.

Also, in the video generation processing apparatus of the present invention, the related-video conditions contain the imaging position information and the date/hour information. Therefore, the desired object can be monitored from multiple angles.

Also, in the video generation processing apparatus of the present invention, the related-video conditions contain position information of neighboring areas adjacent to a position indicated by the imaging position information and the date/hour information. Therefore, the desired object can be monitored in a wide range.

Also, in the video generation processing apparatus of the present invention, the related-video conditions contain position information of invisible areas that are not picked up in the base video and the date/hour information. Therefore, the area that becomes the dead angle of the imaging apparatus that shoots the base video can also be monitored.

Also, in the video generation processing apparatus of the present invention, the related-video condition generating means acquires imaging position information of videos adjacent to the base video in a video feature space to generate the related video conditions. Therefore, the monitoring among a plurality of videos their features are common can be carried out.

Also, in the video generation processing apparatus of the present invention, the related-video condition generating means acquires imaging position information of videos having a relevancy with the base video in meaning contents to generate the related video conditions. Therefore, the monitoring among a plurality of videos that are common in meaning contents can be carried out.

Also, in the video generation processing apparatus of the present invention, respective videos are ordered in response to a priority rule when the related video contains at least two videos. Therefore, displays of the related videos can be aligned in closer order to the user's desired video.

Also, in the video generation processing apparatus of the present invention, the additional information of respective videos stored in the video storing means contain imaging position information, date/hour information, and imaging apparatus information, and a data structure of the video storing means is composed of a two-dimensional arrangement in which a first axis indicates the imaging position information and a second axis indicates the date/hour information and then information of the imaging apparatus that shot a predetermined imaging position at a predetermined date/hour are saved into a cell at which a predetermined imaging position information and a predetermined date/hour information intersect with each other. Therefore, the video can be acquired quickly from the video storing means.

A video generation processing method of the present invention for processing a plurality of videos, which are related with each other to satisfy predetermined conditions, among videos picked up by a plurality of imaging apparatus to display, comprises the steps of acquiring imaging position information of a base video that meets first predetermined conditions from video storing means for storing the videos picked up by the plurality of imaging apparatus and additional information of respective videos; generating related-video conditions based on the acquired imaging position information and data/hour information contained in the first predetermined conditions; and acquiring a related video that meets the related-video conditions from the video storing means.

Also, a video storing apparatus of the present invention for storing videos picked up by a plurality of imaging apparatus and additional information of respective videos, wherein the additional information of respective videos contain imaging position information, date/hour information, and imaging apparatus information, and a data structure of the video storing means is composed of a two-dimensional arrangement in which a first axis indicates the imaging position information and a second axis indicates the date/hour information and then information of the imaging apparatus that shot a predetermined imaging position at a predetermined date/hour are saved into a cell at which a predetermined imaging position information and a predetermined date/hour information intersect with each other.

In the present invention, first, there are provided a video database in which video data and imaging position information as attribute information of respective video data are recorded, and a video generation processing method of searching the video showing the same spot as the imaging position shown in the base video as the related video when the base video or the search key to decide uniquely the base video is pointed, and then correlating a plurality of videos consisting of the base video and the related video as the multi-angle video.

Therefore, the video of other camera that caught the same spot as the desired video can be viewed easily, and thus an effect of reducing a time and labor required to re-search the video with regard to the camera installing position, etc. can be attained. Also, the desired object can be monitored at multiple angles by monitoring the videos as the resultant multi-angle video, and an effect of reducing the dead angle can be achieved.

Second, there are provided a video database in which video data and imaging position information as attribute information of respective video data are recorded, and a video generation processing method of searching the video showing neighboring areas adjacent to the imaging position shown in the base video as the related video when the base video or the search key to decide uniquely the base vide is pointed, and then correlating a plurality of videos consisting of the base video and the related video as the multi-angle video.

Therefore, the video of other camera that caught surrounding spots of the desired video can be viewed easily, and thus an effect of reducing a time and labor required to re-search the video with regard to the camera installing position, etc. can be attained. Also, the desired object can be monitored in a wide range by monitoring the videos as the resultant multi-angle video, and the monitoring to pay attention to the surrounding areas can be achieved.

Third, there are provided a video database in which video data and imaging position information as attribute information of respective video data are recorded, related-video condition generating means which contains information of invisible areas of respective cameras, and a video generation processing method of searching the video showing invisible areas of the imaging position shown in the base video as the related video when the base video or the search key to decide uniquely the base vide is pointed, and then correlating a plurality of videos consisting of the base video and the related video as the multi-angle video.

Therefore, the video of other camera that caught the area as the dead angle in the desired video can be viewed easily, and thus an effect of reducing a time and labor required to re-search the video with regard to the camera installing position, etc. can be attained. Also, the monitoring to complement the spots that cannot picked up by one camera can be carried out by monitoring the videos as the resultant multi-angle video, and an effect of reducing the dead angle can be achieved.

Fourth, there is provided a video generation processing method of correlating a plurality of videos by ordering the videos according to the priority standard based on the imaging position information of respective videos in a means for correlating a plurality of videos consisting of the base video and the related video as the multi-angle video.

Therefore, the videos can be aligned in closer order of the imaging position to the user's desired video and displayed by monitoring the videos as the resultant multi-angle video. Also, the hard-to-see situation generated in viewings a plurality of videos can be improved.

Fifth, there is provided a video generation processing method of having a function of detecting personal features and correlating a plurality of videos constituting the multi-angle video by ordering the videos based on personal information shown in respective videos in a means for correlating a plurality of videos consisting of the base video and the related video as the multi-angle video.

Therefore, the videos can be aligned in higher order of importance of the personal information, which is important for the monitoring, of the videos and displayed by monitoring the videos as the resultant multi-angle video. Also, the hard-to-see situation generated in viewings a plurality of videos can be improved.

Sixth, there is provided a video generation processing method of having a function of switching the base video into any video in display, searching the related video with respect to the base video in response to the switching instruction, and correlating a plurality of videos as the multi-angle video.

Therefore, the video display can be carried out in response to the change of the noticeable video produced during the watching the multi-angle video, and also the high-level monitoring capable of changing the monitoring method as the occasion demands can be implemented.

Seventh, there is provided a video generation processing apparatus having a function for making packages of the multi-angle video, i.e., a plurality of videos based on the user's instruction and recording them, in a video database that has a recording area for accumulating desired videos apart from a normal recording area for recording the video picked up by the monitor camera.

Therefore, individual video data can be handled as a lump of data having the relevancy, and an effect of improving the user interface can be attained. Also, the portability of the video data can be improved.

Eighth, there is provided a video generation processing apparatus having a function for managing integrally three types of information of imaging position, date/hour, and imaging camera about the videos accumulated in the video database by using a data table that can extract one type of remaining information from two types of any information.

Therefore, since a data recording structure is composed of the two-dimensional arrangement in which, for example, a first axis indicates the imaging position information and a second axis indicates the date/hour information and then the camera data that shot the imaging position on the first axis at the date/hour on the second axis are saved into a cell at which the first axis and the second axis intersect with each other. Thus, an effect of improving a searching speed of the video data that are featured by the imaging position information or the date/hour information or both information can be achieved.

As a rule, the monitoring can be carried out at the higher-security level according to these inventions.

### BRIEF DESCRIPTION OF THE DRAWINGS

FIG. 1 is a block diagram showing a schematic configuration of a video generation processing apparatus of the present invention;

FIG. 2 is a view showing a recording structure of a video database in an embodiment 1 of the present invention;

FIG. 3 is a view showing an example of a map information managing method of a monitored area in the embodiment 1 of the present invention;

FIG. 4 shows processing flows in the overall apparatus when camera ID and date/hour information are input as search keys, in the embodiment 1 of the present invention;

FIG. 5 is a view showing an example of a multi-angle video display when the camera ID and the date/hour information are input as the search keys, in the embodiment 1 of the present invention;

FIG. 6 is a flowchart of operations of related-video condition generating means when the camera ID and a time interval are input as the search keys, in the embodiment 1 of the present invention;

FIG. 7 is a view showing an operational outline when a multi-angle is instructed during playing a single video, in the embodiment 1 of the present invention;

FIG. 8 is a view showing an operational outline when the camera ID and the date/hour information are input as the search keys, in an embodiment 2 of the present invention;

FIG. 9 is a flowchart of operations of the related-video condition generating means when the camera ID and the date/hour information are input as the search keys, in the embodiment 2 of the present invention;

FIG. 10 is a view showing an example of an invisible area and invisible area information, in an embodiment 3 of the present invention;

FIG. 11 is a view showing an operational outline when the camera ID and the date/hour information are input as the search keys, in the embodiment 3 of the present invention;

FIG. 12 is a flowchart of operations of the related-video condition generating means when the camera ID and the date/hour information are input as the search keys, in the embodiment 2 of the present invention;

FIG. 13 is a view showing an example of a relevance ratio and a reproducing rate as evaluation of the video based on an imaging range, in an embodiment 4 of the present invention;

FIG. 14 is a view showing an outline of a base video switching operation in reading a multi-angle video, in an embodiment 5 of the present invention;

FIG. 15 shows processing flows in displaying means when the switching of the base video is instructed in reading the multi-angle video, in the embodiment 5 of the present invention.

FIG. 16 is a view showing an overall configuration of the video generation processing apparatus, in an embodiment 6 of the present invention;

FIG. 17 is a view showing a data table for managing imaging position and date/hour, and imaging camera information, in an embodiment 7 of the present invention;

FIG. 18 shows processing flows between related-video searching means and a video database when the imaging position and the date/hour are used as video conditions, in the embodiment 7 of the present invention;

FIG. 19 is a block diagram showing a schematic configuration of the video searching/reading apparatus in the related art; and

FIG. 20 is a view showing an example of a method of displaying the multi-angle video based on personal features.

In above Figures, a reference numeral 101 is displaying means, 102 multi-angle video generating means, 103 related-video condition generating means, 104 video searching/synthesizing means, 105 video database, 106 related-video searching means, 107 related-video synthesizing means, 201 video data area, 202 time information, 203 video data, 204 imaging position information, 205 data every video data, 401 inputting process in the displaying means, 402 process of sending out search key information from the displaying means, 403 process of searching the video adapted to the search key from a video database, 404 process of acquiring imaging position information from the video database as the searched result, 405 process of sending out related video conditions to the video searching/synthesizing means, 406 process of searching the video that is adapted to the related video conditions from the video database, 407 process of acquiring the related video from the video database, 408 process of sending out the multi-angle video to the displaying means, 501 input screen in the displaying means, 502 search key input by the user, 503 output screen in the displaying means, 504 base video, 505 related video, 601 process of receiving the search key from the displaying means, 602 process of setting an initial value of a date/hour variation, 603 process of searching the video data that are adapted to the search key from the video database to decide whether or not the adapted video data, i.e., the base video are present, 604 process of acquiring imaging position information of the base video from the video database, 605 process of setting the imaging position information and the date/hour variation value of the base video as related video conditions, 606 process of sending out the related video conditions to the video searching/synthesizing means, 607 process of incrementing the date/hour variation, 608 process of deciding whether or not the process in a predetermined time interval is ended, 701 single video display screen on the displaying means, 702 multi-angle instruction button, 703 user's input of the multi-angle instruction, 704 video data that are being played on the displaying means, 705 imaging position information of the video data that are being played, 706 related video, 707 multi-angle video display in the displaying means, 801 input screen on the displaying means, 802 user's input of the search key, 803 base video that is adapted to the search key, 804 imaging position information of the base video, 805 neighboring position to the imaging position of the base video, 806 related video, 807 output screen on the displaying means, 901 process of receiving the search key from the displaying means, 902 process of searching the video data that are adapted to the search key from the video database to decide whether or not the adapted video data, i.e., the base video are present, 903 process of acquiring the imaging position information of the base video from the video database, 904 process of calculating neighboring area position to the imaging position information of the base video, 905 process of setting the neighboring area position and the date/hour information as related video conditions, 906 process of sending out the related video conditions to the video searching/synthesizing means, 1001 monitor camera X, 1002 obstacle existing in a monitored area, 1003 current imaging area of the monitor camera X, 1004 invisible area when the imaging area of the monitor camera X is 1003, 1005 invisible area information of each camera, 1101 input screen on the displaying means, 1102 user's input of the search key, 1103 base video, 1104 imaging position information of the base video, 1105 invisible area information, 1106 invisible area of the camera, 1107 related video having the invisible area as the imaging position information, 1108 output screen on the displaying means, 1201 process of receiving the search key from the displaying means, 1202 process of searching the video data that are adapted to the search key from the video database to decide whether or not the adapted video data, i.e., the base video are present, 1203 process of acquiring the imaging position information of the base video from the video database, 1204 process of calculating invisible area position to the imaging position information of the base video, 1205 process of setting the invisible area position and the date/hour information as related video conditions, 1206 process of sending out the related video conditions to the video searching/synthesizing means, 1301 map of the monitored area, 1302 imaging range pointed in the searching conditions, 1303 imaging range which is shown on the video as the ordering object, 1401 input screen on which the multi-angle video is displayed, 1401-a base video, 1401-b related video \mathring{1}, 1401-c related video \mathring{2}, 1402 input for indicating the related video \mathring{2} 1401-c as the base video, 1403 output screen for displaying the multi-angle video reconstructed by using the related video \mathring{2} 1401-c as the base video, 1501 display screen on which the multi-angle video is displayed, 1502 information of the video displayed on the display screen, 1503 input for indicating one related video being now displayed on the display screen as the base video, 1504 video data corresponding to the indicated video in the owned video data information, 1505 search key that the display means sends out to the related-video condition generating means, 1601 displaying means, 1602 video database, 1603 normal recording area, 1604 saving area, 1701 first axis having an area ID value as imaging position information, 1702 second axis having date/hour information, 1703 two-dimensionally arranged data saving area having a camera ID set of the camera that shot the area indicated by the first axis 1701 on the date/hour indicated by the second axis as a value, 1801 video searching/synthesizing means, 1802 video database, 1803 data table, 1804 normal recording area for recording the video data in unit of camera, 18-a process by which the video searching/synthesizing means sends out the searching conditions, 18-b process of acquiring information of the camera that shot the imaging position indicated by the data table in the searching conditions on the indicated date/hour, 18-c process of searching the video that meets the search key based on the information in the data table, 18-d process of sending out the video that is adapted to the searching conditions to the video searching/synthesizing means, 1901 display terminal, 1902 video searching means, 1903 video database, 1904 process by which the display terminal sends out the searching conditions to the video searching means, 1905 process by which the video searching means searches the adapted video from the video database based on the searching conditions, 1906 process by which the video searching means acquires the searched result or the adapted video from the video database, and 1907 process by which the video searching means sends out the searched result or the adapted video to the display terminal.

### BEST MODE FOR CARRYING OUT THE INVENTION

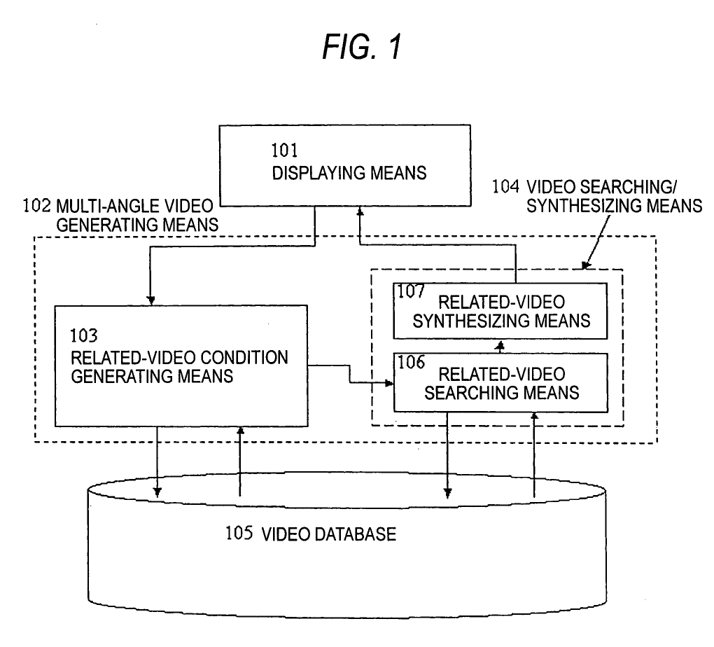

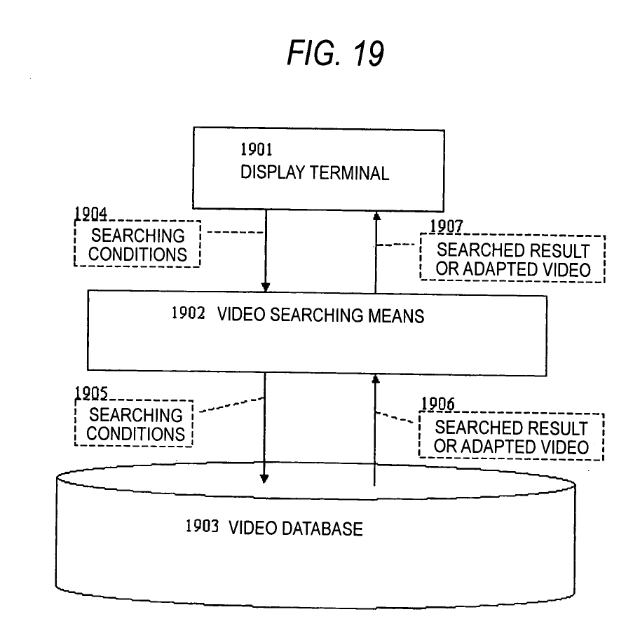

Embodiments of the present invention will be explained with reference to FIG. 1 to FIG. 19 hereinafter. In this case, the present invention is not restricted to these embodiments at all, and the present invention may be embodied in various modes within a scope that does not depart from the gist thereof.

### Embodiment 1

As a first embodiment, a video generation processing apparatus for generating a multi-angle video consisting of a pointed base video and a video showing the same spot as the base video will be explained with reference to FIG. 1 to FIG. 7 hereunder.

In this event, the base video set forth in this specification signifies the video that serves as the basis in generating the multi-angle video, and the related video signifies the video that has a relevance to attribute information or video features of the base video.

In this case, a method of pointing the base video is not particularly mentioned. However, explanation will be made in the following description under the assumption that the base video is pointed by designating a camera ID or the camera ID and date/hour information as the search key.

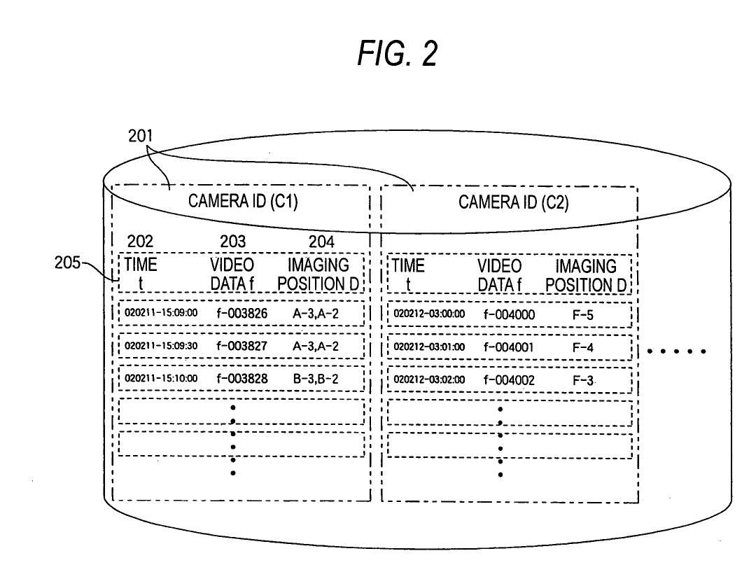

First, a configuration of the video generation processing apparatus will be explained with reference to FIG. 1 and FIG. 2 hereunder.

In FIG. 1, displaying means 101 has a function of inputting the camera ID and date/hour or a period, if necessary, as the search key, and a function of receiving/displaying the multi-angle video. Multi-angle video generating means 102 is constructed by two means of related-video condition generating means 103 and video searching/synthesizing means 104. The related-video condition generating means 103 searches the video that is adapted to the camera ID and the date/hour information obtained from the displaying means 101, i.e., the base video from a video database 105, and then acquires imaging position information of the base video. The acquired imaging position information and the date/hour information are set as related-video conditions, and sent out to related-video searching means 106. The related-video searching means 106 collects all the adapted videos from the video database 105, based on the related-video conditions obtained from the related-video condition generating means 103. All the collected related videos are sent out to related-video synthesizing means 107. The related-video synthesizing means 107 correlates the related video acquired by the related-video searching means 106 with the base video and synthesize them as the multi-angle video. Then, the multi-angle video is sent out to the displaying means 101.

In this case, in the following description, the related-video searching means 106 and the related-video synthesizing means 107 are referred to as the video searching/synthesizing means 104 collectively.

The video database 105 is a database in which the video data as well as a shot time and imaging position information of each video data are saved as recorded data of the monitor camera and from which respective data can be searched under the condition of any one of camera ID, date/hour, and imaging position or any combination data of them.

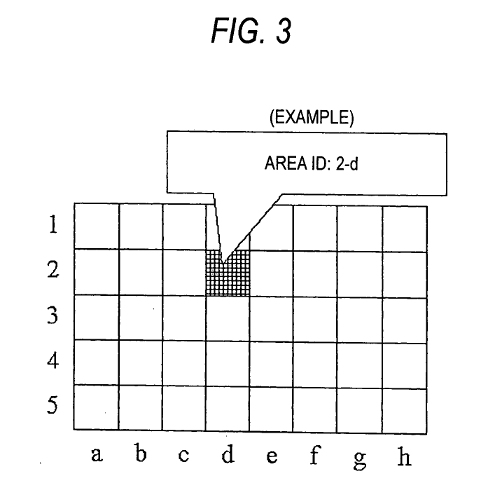

An example of a data structure saved in the video database 105 is shown in FIG. 2. In the video database 105, the video is recorded in each area 201 allocated to every camera, and date/hour information 202, video data 203, and imaging position data 204 are recorded as data 205 in each video frame. FIG. 2 is a view showing a recording structure of a video database in an embodiment 1 of the present invention. As the video data 203, the video data itself may be save or IDs by which the video data recorded in another area can be referred to uniquely may be saved. FIG. 2 shows an example recorded by the latter. The imaging position data 204 may take various modes according to the method of managing a map of the monitored areas. As an example, as shown in FIG. 3, a method of managing the monitored areas as a set of small areas which are divided into partial areas and to which a proper ID (which is referred to as an “area ID” hereinafter) is allocated respectively is illustrated. In this case, the imaging position data 204 recorded in the video database 105 can be recorded as a set of the area IDs as set forth in FIG. 2. Also, as another example, there is a method of providing a coordinate system, which has one point of the monitored areas as a basis, and then managing the monitored area by the coordinate value. In this case, the imaging position data 204 can be represented by the data that that consists of the coordinate values of respective apexes of the rectangle indicating the imaging range.

The recording database structure and the imaging position data format mentioned above are merely one example, and their recording formats can be varied flexibly.

In the description of the present embodiment, the case where the data are managed by using the recording database shown in FIG. 2 and the map information of the monitored areas shown in FIG. 3 will be explained hereunder.

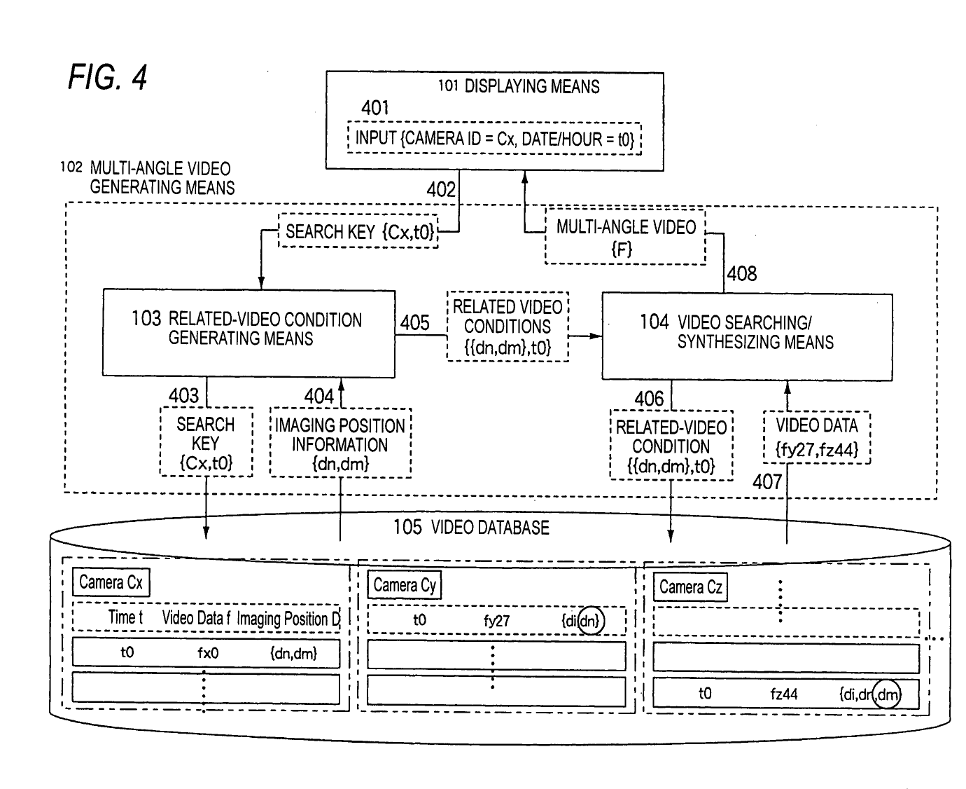

The video generation processing apparatus of the present invention operates in compliance with processing flows shown in FIG. 4.

Step 401: The search key is input by the user via the displaying means 101. In FIG. 4, the camera ID={Cx} and the date/hour {t0} are input into the search key as an example.

Step 402: The displaying means 101, when received the search key input and the search instruction, sends out the search key data {Cx, t0} to the related-video condition generating means 103.

Step 403: The related-video condition generating means 103 searches the video adapted to the search key from the video database 105, based on the received search key data {Cx, t0}. In an example in FIG. 4, the video picked up by the camera Cx at a time t0 is searched to find the adapted video data fx0.

Step 404: As the searched result, the related-video condition generating means 103 receives a set {dn, dm} of area IDs as the imaging position information that is one of attribute information of the adapted video data fx0.

Step 405: The related-video condition generating means 103 sets the date/hour information {t0} given by the search key and the acquired imaging position information {dn, dm} as related video conditions {{dn, dm}, t0} and then sends out them to the video searching/synthesizing means 104.

Step 406: The video searching/synthesizing means 104 searches the video, which is adapted to the related video conditions {{dn, dm}, t0}, from the video database. In the case of this example, the videos whose area ID contains any of {dn, dm} as the imaging position information and which satisfy the time information of t0 are totally searched from the video database 105 based on the related video conditions.

Step 407: The video searching/synthesizing means 104 receives a set of video data constructed by the videos (in an example in FIG. 4, fy27, fz44) that meet the related video conditions, as the searched result.

Step 408: The video searching/synthesizing means 104 generates the multi-angle video F based on the base video fx0 and the related videos fy27, fz44 acquired in Step 407, and then sends out the video to the displaying means 101. In this case, the base video fx0 may be accepted from the video database 105 to the video searching/synthesizing means 104 at a point of time in Step 403 or may be fetched at a point of time in Step 407.

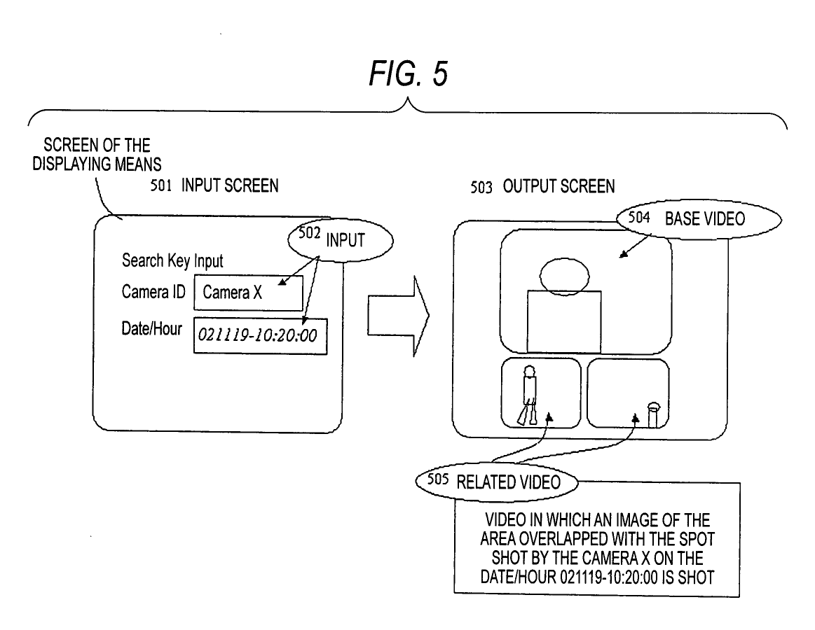

An example of a display of the multi-angle video implemented by the present embodiment is shown in FIG. 5.

When a camera X and 2002/11/19-10:20:00 as an input 502 are input into a camera ID and a date/hour on an input screen 501 of the displaying means as the search keys, video searching and video synthesizing processes are carried out in compliance with the above operation in the present embodiment. Then, the multi-angle video consisting of the video picked up by the camera X at that time and the videos showing the same spot as that picked up by the camera X or overlapped spots at the same time is displayed on an output screen 503.

In this case, in the video generation processing apparatus in the present embodiment 1, a predetermined time interval before and after the pointed date/hour may be allowed by improving a flexibility in the date/hour information as one of the search keys. Also, the date/hour information may be pointed preciously by a time interval, i.e., a start time and an end time.

When the time interval is pointed, time information as one element to decide the base video is updated at every predetermined interval while using the start time of the pointed time interval as an initial value. The base video is searched again to correspond to this. As a result, since the base video is updated at any time and the imaging position information of the base video is also changed, the contents of the related video conditions being set by the related-video condition generating means are also updated at any time.

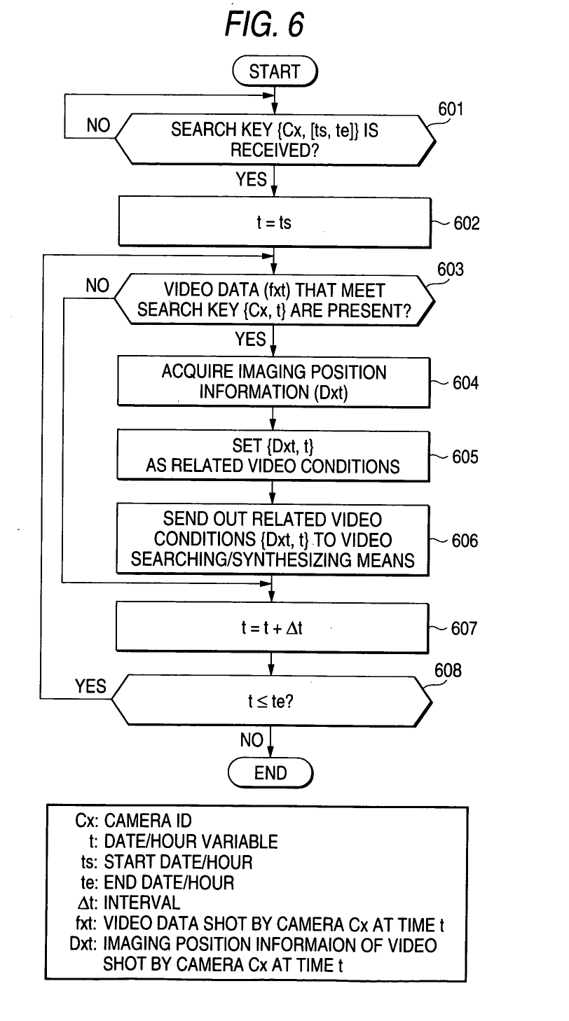

When the camera ID and the time interval are input as the search key, the related-video condition generating means 103 operates in accordance with a flowchart of operations shown in FIG. 6. This operation is executed by eight steps as follow.

Step 601: To receive a camera ID Cx and a start time ts and an end time te of the time interval as the search key.

Step 602: To set the start time ts as a date/hour variation t.

Step 603: To set {Cx,t} as the search key, and search the video data that are adapted to the search key, i.e., the base video from the video database 105.

Step 604: To acquire the imaging position information Dxt of the base video when the base video is present.

Step 605: To set the related-video conditions to the imaging position information and the time value {Dxt,t} of the base video.

Step 606: To send out the set related video conditions {Dxt,t} to the video searching/synthesizing means 104.

Step 607: To add a predetermined time interval Δt to the date/hour variation.

Step 608: To goes back to step 603 to repeat the processes if a value of the date/hour variable does not exceed the end time.

With the process in the related-video condition generating means 103, the video searching/synthesizing means 104 searches the videos that meet the related video conditions from the video database 105 based on the related video conditions received from the related-video condition generating means 103, and then generates the multi-angle video from the derived videos.

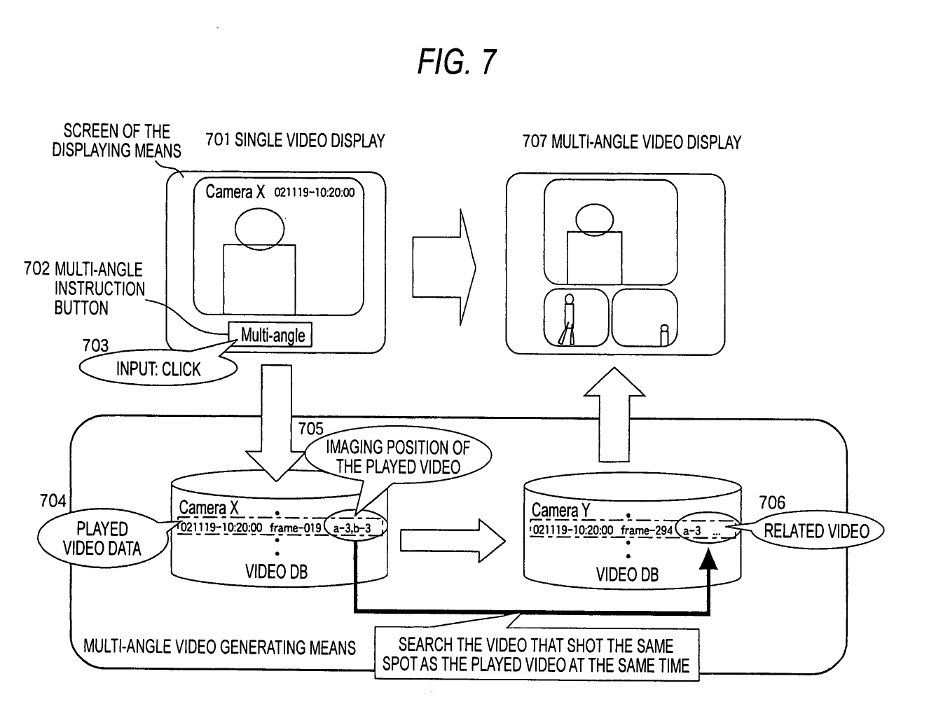

Also, in the video generation processing apparatus in the present embodiment 1, the method of reading the desired multi-angle video by inputting the camera ID and the data/hour information as the search keys is described. In this case, the multi-angle video display for displaying the base video that is being played as well as related video associated with this video can be implemented by providing the normal single video displaying function and the inputting means that permits the user to instruct the multiple angle during reading the video to the video generation processing apparatus of the present invention. An operational outline in this case is shown in FIG. 7.

In FIG. 7, a configuration in which a button is provided onto the display screen 101 as the inputting means used to instruct the multi-angle display will be explained as an example hereunder. When the user clicks 703 a multi-angle display instruction button 702 displayed on a display 701 while the video of the camera X, for example, is being played on the display screen 701, the related-video condition generating means 103 searches video data 704 of the camera X that is being played and recognizes this as the base video.

The camera ID is set via the display screen in the embodiments shown in FIG. 4 and FIG. 5 but the camera ID whose video is being played is set herein, and the date/hour information is also set via the display screen in the above embodiments but the imaging time of the video that is being played is set herein. Subsequent processes are similar to the processes described in the embodiments shown in FIG. 4, FIG. 5. First, imaging position information 705 of the base video, i.e., the video of the camera X at the present play time 13:24:00 is acquired. Here, a-3, b-3 expressed by the area ID are obtained. Then, the videos that picking up the area ID a-3 or b-3 at 13:24:00 are searched/collected from the vide database by using the acquired imaging position 705 and the play time value as the related-video condition. FIG. 7 shows that a frame-294 containing the area a-3 in the imaging position is sensed from the video of the camera Y. All the related videos collected in this manner are synthesized as the multi-angle video and displayed on the output screen 707. This process is repeated every video frame of the played video, and the multi-angle video is displayed.

In this case, in the explanation of the present embodiment, the method of managing the monitored area two dimensionally is described as the method of managing the map of the monitored area. But the map may be managed three dimensionally by adding the height direction from the ground.

In this case, in the explanation of the present embodiment, in the multi-angle video shown in FIG. 5 and FIG. 7, the base video is displayed large and the related video is displayed small. But this format is a mere example and various displaying ways may be applied.

As described above, in the present embodiment, the function of generating the multi-angle video consisting of the base video and the video showing the same spot as the imaging position shown in the base video as the related video when the base video or the search key to decide the base video is pointed is provided. Thus, since the object shot by the particular camera can be viewed from the multiple angles, an effect of reducing the dead angle can be achieved.

Also, in response to further viewing requests such that “the monitoring person wishes to watch the video from the different angle”, “the monitoring person wishes to check whether or not the spot was shot by other cameras”, etc., that the monitoring person often feels during the video monitoring, this apparatus permits the user to realize such viewing without re-search the desired video and without regard to the monitoring processes such as imaging position, time, shooting camera, etc. Thus, an effect of improving the searching efficiency can be achieved.

Also, with the progress of reduction in cost of the camera and with the advent of the wide-angle camera such as the fisheye camera, etc., the driving camera, and the like, in recent years various monitoring ways can be executed by combinational use of the cameras, etc. Because the method of intersecting the imaging ranges of a plurality of cameras to monitor the object from multiple angles is now being generalized as one of them, the method of watching effectively a plurality of camera videos is expected as the viewing method. Thus, the video generation processing apparatus of the present invention capable of viewing the multi-angle video has an important practical effect.

Here, when the driving camera is utilized, the imaging spot in the video is changed every time. In this case, the related video displayed on the displaying means 101 is not limited to the video picked up at the same time as the base video. In other words, the time information in the related video conditions used in step 406 in FIG. 4 may be set to the time before or after the time t0 instructed by the search key (t0±turning period time of the driving camera). When doing this, the videos of other cameras, which may shoot the same spot as the base video at the same time, can be extracted as the related video.

### Embodiment 2

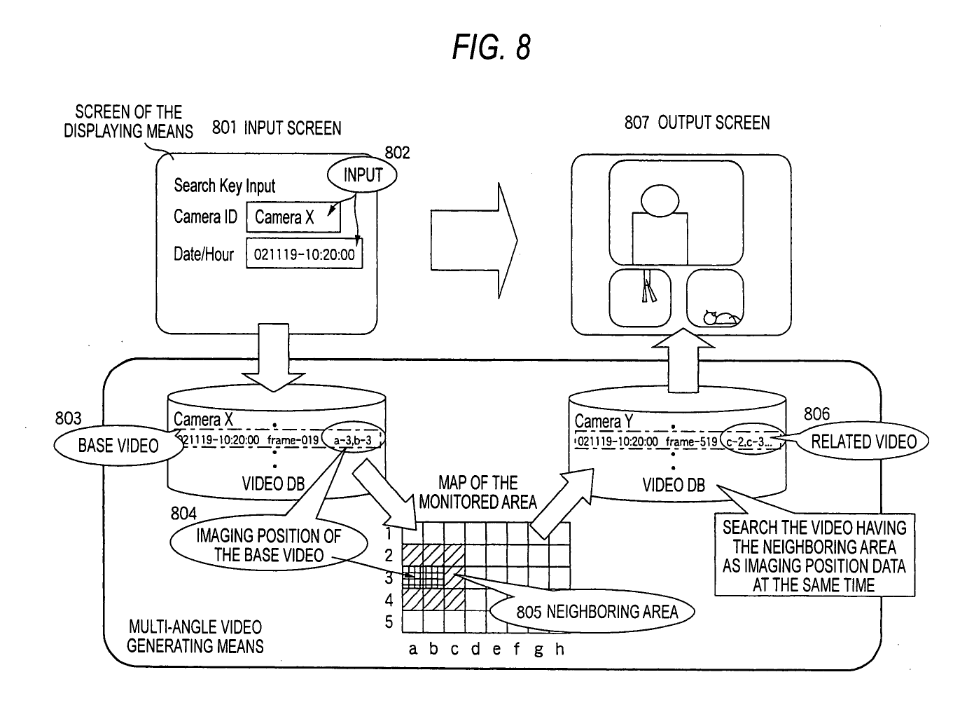

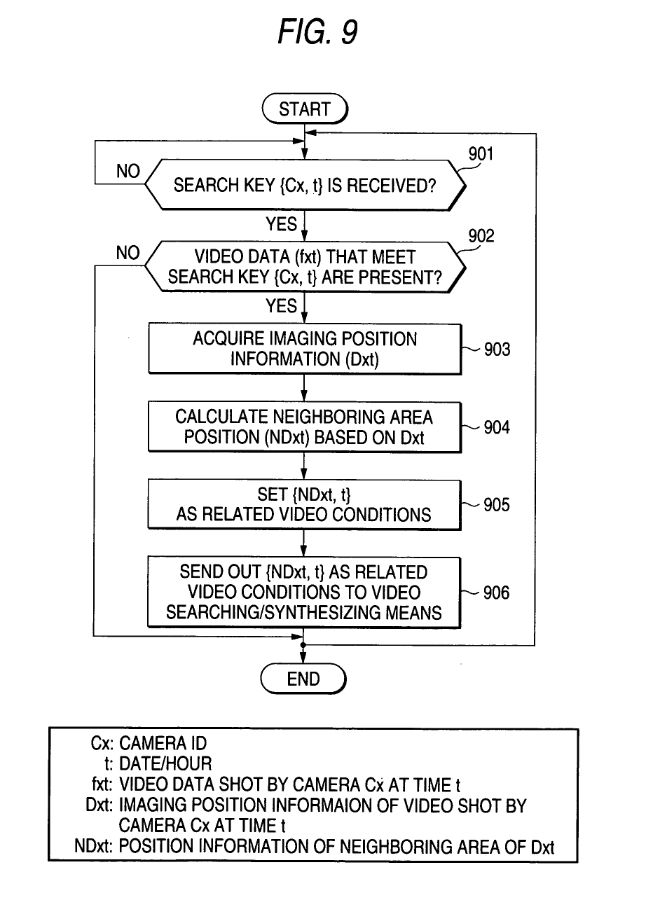

As an embodiment 2, a video generation processing apparatus having a function of generating the multi-angle video consisting of the base video and the video showing the neighboring area of the imaging position, which is shown in the base video, as the related video when the base video is pointed will be explained with reference to FIG. 8 and FIG. 9 hereunder.

In this case, respective means constituting the present embodiment are identical to the embodiment 1 except internal functions of the related-video condition generating means, and also the recording structure of the video database, the map information of the monitored area, and others, if not particularly mentioned in the following explanation, are similar to the embodiment 1. Therefore, different portions from the embodiment 1 will be explained mainly hereunder.

An outline of multi-angle video monitoring of the neighboring areas implemented by the embodiment 2 will be explained with reference to FIG. 8 hereunder.

The user inputs the camera ID and the date/hour information 802 onto an input screen 801 as the search key. For example, in the example in FIG. 8, the camera X and 2002/11/19-10:20:00 are pointed. The video adapted to the input search key, i.e., the video being shot by the camera X at 2002/11/19-10:20:00 is searched from the video database 105, and a searched video frame-019 is set as the base video 803. Since imaging position information 804 recorded as the attribute information of the base video frame-019 have the area IDs a-3, b-3, the neighboring areas are searched as the areas having the area IDs a-2, a-4, b-2, b-4, c-2, c-3, c-4 based on the map information. The videos having the neighboring area positions detected herein as imaging position data are searched as related videos 806. FIG. 8 shows that a frame-519 of the camera Y having c-2, c-3 as the imaging position is searched. The multi-angle video consisting of all the related videos searched in this manner and the base video frame-019 is displayed on the output screen 807.

As described above, in order to realize the function of setting the video showing neighboring area positions to the base video as the related-video conditions, the related-video condition generating means in the present embodiment 2 has the map information of the monitored area and a function of calculating the neighboring position to the certain imaging position based on the map information, in addition to the embodiment 1.

The related-video condition generating means operates in compliance with a flow shown in FIG. 9, and is constructed by six steps as follow.

Step 901: To receive the camera ID Cx and the date/hour information t from the displaying means as the search key.

Step 902: To search the video data that are adapted to the search key {Cx,t}, i.e., the base video from the video database.

Step 903: To acquire the imaging position information Dxt of the base video when the base video are present.

Step 904: To calculate the neighboring area position NDxt to the imaging position information Dxt of the base video acquired in Step 903 based on the map information of the monitored area.

Step 905: To set the related video conditions to the neighboring area position and the date/hour information {NDxt,t} calculated in Step 904.

Step 906: To send out the set related-video condition data to the video searching/synthesizing means.

In this case, in Step 904, the method of calculating the position information of the neighboring areas from the imaging position of the base video becomes different according to the method of managing the map information of the monitored area. In the managing method utilized in the present embodiment as an example in FIG. 3, the monitored areas area managed like a matrix that is divided in length and width. In this case, eight neighboring cells of each area ID are sensed as the neighboring areas. Here, if the area IDs are managed by the matrix number, the neighboring areas can be sensed by a simple calculation.

In the video generation processing apparatus in the embodiment 2, the date/hour information as one of the search keys can be pointed by the time interval.

Also, in the video generation processing apparatus in the embodiment 2, the method of viewing the multi-angle video consisting of the base video adapted to the search key and the neighboring videos by inputting the camera ID and the date/hour information as the search key is described. However, if the normal single video displaying function and the inputting means for instructing the formation of the multi-angle video during viewing the video are provided to the video generation processing apparatus of the present invention, the multi-angle video consisting of the base video and the video showing the neighboring videos of that video on occasion can be viewed by executing the similar processes to the above processes while using the video now in play as the base video.

Also, in the video generation processing apparatus in the embodiment 2, the related video conditions are set as the neighboring video having the physical positional relationship with the imaging position. However, the neighboring video in the video feature space may be selected as the neighboring video in meaning.

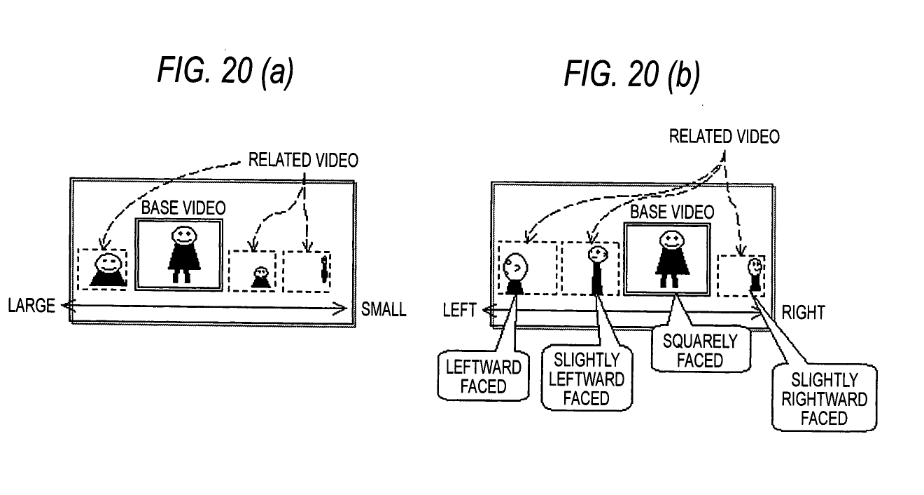

As the neighboring video in the video feature space, for example, the camera video showing the person having the face feature close to the face feature of the person shown in the base video can be selected as the related video by setting the video feature space to the feature space representing a feature quantity of the face. An example of a method of displaying the multi-angle video at this time is shown in FIG. 20. The videos are displayed in order of size of the persons shown in the base video and the related videos in FIG. 20(a), and the videos are aligned and displayed in response to the face direction in FIG. 20(b). Also, if the video feature space is set to the color feature space such as typical color, coloring, texture, etc., the camera video having the color feature similar to the base video can be set as the related video. Also, if the video feature space is set to a motion feature quantity such as moving direction, speed, etc., the camera video showing the subject having the motion information similar to the moving subject shown in the base video can be set as the related video.

Also, in the video generation processing apparatus in the embodiment 2, the related-video conditions are set to the neighboring video in the physical position relationship with the imaging position. But the neighboring video resemble in meaning the camera motion of the base video may be set as the related video. For example, if the base video is the video that is subjected to zooming operation, the video of other camera that is similarly subjected to zooming operation can be selected as the related video. Alternately, as the neighboring video in meaning, the video in which the same or similar event (e.g., the door was open, the person ran, etc.) as the event occurred in the base video occurred can be set as the related video.

As described above, in the present embodiment, the function of generating the multi-angle video consisting of the base video adapted to the search key and the video giving the neighboring position of the imaging position shown in the base video as the related video when the camera ID is pointed as the search key is provided. Thus, the object shot by the particular camera can be viewed in a wide range and also an effect of reducing the dead angle can be achieved.

Also, normally the monitor video is often used in the verification, or the like after the occurrence of the event. At that time, the video showing the surroundings in addition to the video of the event occurring site are considered the important video to grasp that situation. In such application, conventionally the video showing the desired position must be re-searched and viewed to take account of the installing position of the monitor camera, or the like. The apparatus of the present invention can omit the searching time and labor and realize easily the monitoring of the surrounding area.

In this manner, the monitoring in the present embodiment can attain an effect of enhancing the security level much more and an effect of improving the searching effect, and has a significant practical effect.

### Embodiment 3

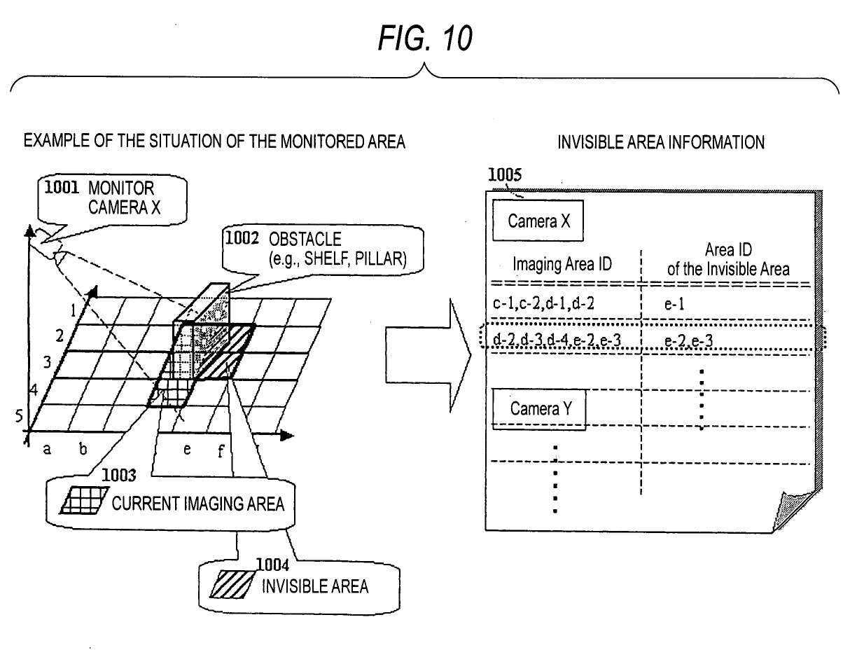

As an embodiment 3, a video generation processing apparatus having a function of generating the multi-angle video consisting of the base video and the video showing an invisible area of the imaging position of the base video as the related video when the base video is pointed will be explained with reference to FIG. 10 to FIG. 12 hereunder.

In this case, the present embodiment is similar in structure to the embodiment 1, and comprises the displaying means, a multi-angle video generating means consisting of the related-video condition generating means and the video searching/synthesizing means, and the video database.

Since the displaying means, the video database, and the video searching/synthesizing means have the same function as the embodiment 1 respectively, their explanation will be omitted herein.

The related-video condition generating means has the map information of the monitored area, invisible area position information of respective cameras, and a function of calculating invisible area positions based on the map information, the invisible area position information, and the imaging position information of respective cameras, in addition to the function in the embodiment 1.

The “invisible area” described in this specification signifies the area that is positioned in a range that the camera can shoot but is rendered invisible by an obstacle such as shelf, pillar, or the like. An example of the invisible area information is shown in FIG. 10.

Suppose that an obstacle 1002 such as shelf, pillar, or the like is present in the monitored area in which a monitor camera X 1001 is provided. The area 1004 that is rendered invisible by the obstacle 1002 although the current imaging area is positioned within a current imaging area 1003 by using pan/tilt/zoom functions of the monitor camera X 1001 is defined as the invisible area.

Invisible area information 1005 describes the information of the invisible area in the imaging area of the camera. The invisible area information contained in the related-video condition generating means give the data indicating which area is rendered invisible when the particular camera picks up the image of the particular area, and are previously set and prepared.

Also, the related-video conditions set by the related-video condition generating means set the invisible area information of the imaging area of the video that meets the search key, and the time information.

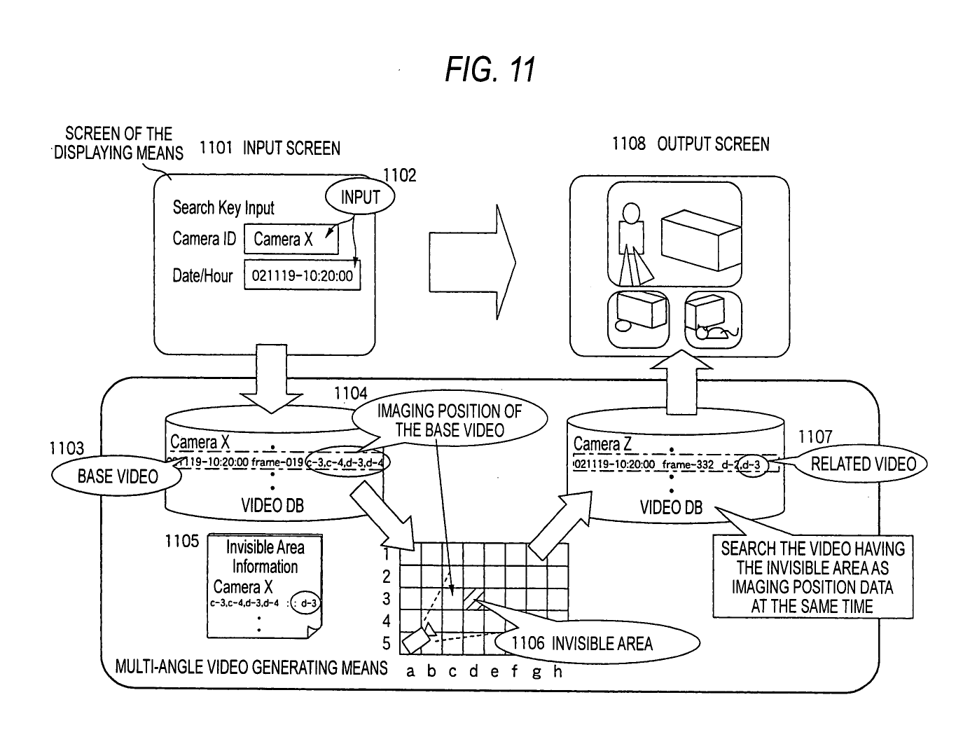

An outline of the multi-angle video viewing of the invisible area implemented by the embodiment 3 will be explained along FIG. 11 hereunder.

The user inputs the camera ID and date/hour information 1102 onto an input screen 1101 as the search key. For example, in FIG. 11, the camera X and 2002/11/19-10:20:00 are pointed. The video adapted to the input search key, i.e., the video picked up by the camera X at 2002/11/19-10:20:00 is searched from the video database, and the searched video frame-019 is set as a base video 1103. Since an imaging position 1104 recorded as attribute information of the base video frame-019 has area IDs c-3, c-4, d-3, d-4, an invisible area 1106 with respect to the current imaging position is searched as the area having an area ID d-3 based on invisible area information 1105. The video having the invisible area 1106 detected herein as the imaging position data is detected as a related video 1107. FIG. 11 shows that a video frame-332 of the camera Y having d-2, d-3 as the imaging position is detected. The multi-angle video consisting of all the related videos detected in this manner and the base video frame-019 is displayed on an output screen 1108.

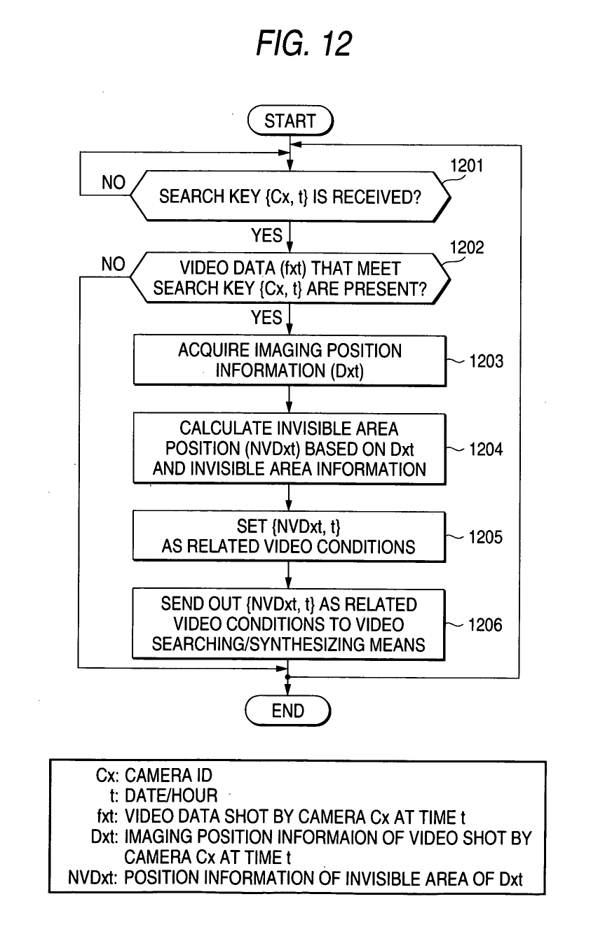

The related-video condition generating means operates in compliance with a flow shown in FIG. 12, and includes six steps as follow.

Step 1201: To receive the camera ID Cx and the date/hour information t from the displaying means as the search key.

Step 1202: To search the video data that are adapted to the search key {Cx,t}, i.e., the base video from the video database.

Step 1203: To acquire the imaging position information Dxt of the base video when the base video is present.

Step 1204: To calculate the invisible area position NVDxt in the current imaging position based on the invisible area information of the camera Cx in answer to the imaging position information Dxt of the base video acquired in step 1203.

Step 1205: To set the related video conditions to the invisible area position and the time value {NVDxt, t} calculated in Step 1204.

Step 1206: To send out the set related video condition data to the video searching/synthesizing means.

In FIG. 10, the method of setting the invisible area ID to respective imaging areas of respective cameras is shown as an example of the invisible area information. The information saving method is not particularly to the above method, and may be attained in an arbitrary mode. Therefore, for example, if the monitored area is given by the coordinate apparatus, the information may be saved in such a mode that the area constitutes the invisible area is pointed when the certain coordinate point is being viewed.

Also, in the present embodiment, the effect that the invisible area information is set previously is described. The invisible area information can be calculated sequentially based on the map information of the monitored area, status information (zoom, pan, tilt, etc.) of the camera, position information of the obstacle, and the like.

In this case, in the video generation processing apparatus in the present embodiment 3, the date/hour information as one of the search keys can be pointed by the time interval.

Also, in the video generation processing apparatus in the present embodiment 3, the method of viewing the multi-angle video consisting of the desired video and the invisible area video by inputting the camera ID and the date/hour information as the search key is described. In this case, if the normal single video displaying function and the inputting means for instructing the formation of the multi-angle video during viewing the video are provided to the video generation processing apparatus of the present invention, the multi-angle video consisting of the base video and the video showing the invisible area videos of that video on occasion can be viewed by executing the similar processes to the above processes while using the video now in play as the base video.

As described above, in the present embodiment, the function of generating the multi-angle video consisting of the base video adapted to the search key and the video giving the imaging position shown in the base video and its invisible areas as the related video when the camera ID is pointed as the search key is provided. Thus, the area in which the obstacle, or the like produces the dead angle in the area caught by the particular camera can be checked simultaneously.

The obstacle such as shelf, pillar, or the like is present in the actual monitoring site, and the area in which the dead angle is produced by the obstacle exists even in the monitoring range of the camera. In order to check whether or not the area having the dead angle is in danger, conventionally the video showing the desired position must be searched again and watched to take account of the providing position of the monitor camera, or the like. However, the apparatus of the present invention can omit such searching time and labor and realize easily the monitoring of the dead angle area.

In this manner, the monitoring in the present embodiment can attain an effect of enhancing the security level much more and an effect of improving the searching effect, and has a significant practical effect.

### Embodiment 4

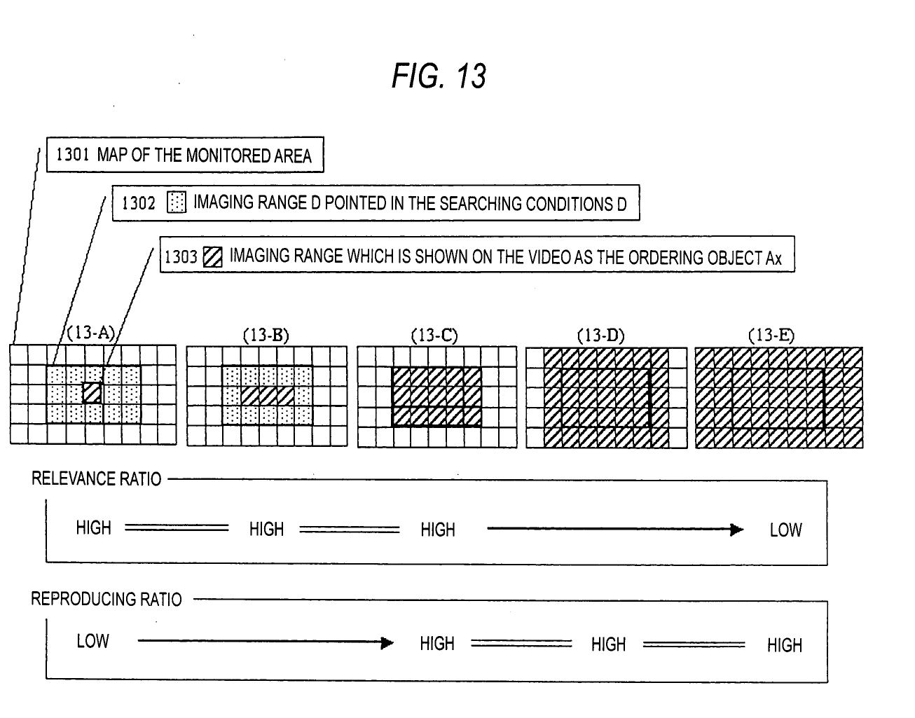

As an embodiment 4, a video generation processing apparatus having the video searching/synthesizing means that contains the priority rule to order the videos constituting the multi-angle video, and a function of constricting the multi-angle video on the basis of priorities of respective videos according to the rule will be explained with reference to FIG. 13 hereunder.

In this case, the invention shown in the embodiment 4 relates to the method of synthesizing the multi-angle video from a plurality of videos, and is relevant to the related video synthesizing means 107 in the video generation processing apparatus shown in FIG. 1. Therefore, this embodiment does not restrict the functions of respective other means constituting the video generation processing apparatus, and can be implemented in any apparatus set forth in the above embodiments 1 to 3.

In the following explanation, the priority rule of the video provided to the related video synthesizing means will be mainly described.

The videos handled in the related video synthesizing means are composed of the base video and the related videos that are collected because of a high relevance to the base video. There is a possibility of collecting a plurality of videos, which needs the ordering, in the related videos in the embodiments 1 to 3. These videos are collected by using the imaging position information as the searching conditions. Therefore, the priority standard based on the imaging position is used as the first standard that orders these videos.

Also, the priority standard based on personal information of the object is used as the second standard that orders the videos. This is because the present invention relates to the monitoring field and the personal information is one of very important information in the monitoring.

First, the first priority standard based on the imaging position will be explained with reference to FIG. 13 hereunder.

The video handled in the related video synthesizing means as the ordering object is acquired from the database as the video that adapted to the imaging position information after such information consisting of a set of area IDs are designated as the related image conditions.

For example, suppose that
D={d0, d1, d2, . . . , dn}
   is pointed as the imaging position information consisting of n area IDs, and the videos having one area ID or more contained in the imaging position information D as the imaging position are acquired as the adapted video. There are u pieces of collected adapted videos, i.e., the videos as the ordering object, and these videos are represented as
f0, f1, f2, . . . , fx, . . . , fu
   respectively. Also, suppose that the imaging positions shown in respective videos fx are represented by a set of m pieces of the area IDs
Ax={ax0, ax1, ax2, . . . , axj, . . . , axm}.

Two following evaluation values are used as the standard that orders the videos f0, f1, f2, . . . , fu.
(1) A ratio of the positions that are adapted to the searching conditions to the imaging positions that are shown in the videos fx as the ordering object
(2) A ratio of the positions in which the video fx is shown to the imaging positions D in the searching conditions

Here, (1) is the index indicating a relevance ratio. For example, an evaluation value is lowered when the video fx shows a lot of locations except the desired position as shown in 13-E of FIG. 13, while an evaluation value is increased when the video fx shows few locations except the desired position as shown in 13-A to C of FIG. 13. Also, (2) is the index indicating a recall ratio. For example, an evaluation value is lowered when the video fx shows only a part of the imaging position pointed by the searching conditions as shown in 13-A of FIG. 13, while an evaluation value is increased when the video fx shows a lot of locations in the pointed imaging position as shown in 13-C to E of FIG. 13. The indices (1) and (2) are in the trade-off relation, but both evaluation values have a highest value in the video that shows completely only the desired position. Therefore, an integral evaluation in which both evaluations are combined with each other is employed. As the integral evaluation, evaluations using a sum or a product of the evaluation values in (1) and (2) or any weighted sum, or the like are considered. Explanation will be made herein under the assumption that a simple sum of both evaluation values is set to a total evaluation value.

An example of a method of calculating respective evaluation values in (1) and (2) is shown concretely.

It is decide by an evaluation value in Eq. (1) whether or not each area IDaxj belonging to an imaging position Ax of the evaluated object video fx is contained in the desired imaging position D.

$$\begin{matrix}axj ∈ Ax , axj ∈ D \to I ( axj ) = 1 \\ axj ∈ Ax , axj ∈ D \to I ( axj ) = 0\end{matrix} \} \qquad ( 1 )$$

By using this, an evaluation value E1 of (1) is decided by Eq. (2).
E1={Σj=0,mI(axj)}/m (2)

Also, an evaluation value E2 of (2) is decided by Eq. (3).
E2={Σj=0,mI(axj)}/n (3)

Where m is the number of elements of the set Ax, and n is the number of elements of the set D.

An evaluation value E is decided by a sum of (1) and (2).
E=E1+E2

If each video fx is evaluated by using this evaluation value E and then the videos are arranged sequentially from the video having the highest evaluation value, respective videos can be displayed in sequence from the video that shows the fewest locations except the desired position but shows the most locations of the desired position.

Next, the priority standard based on the personal information will be explained as the second standard hereunder.

As mentioned above, the personal information are very important in the monitoring field. Therefore, a personal recognizing function is provided to the related-video synthesizing means and a personal recognizing process is applied to respective videos as the ordering object, and then the priority is assigned by using the result.

As the evaluation value based on the personal recognizing result, two following values are used.
(1) Size of the person shown in the video
(2) Direction of the face of the person shown in the video

In this case, when a plurality of persons are shown in one video, the information of the person who is shown largest in the video, the information of the person who is shown in the most central location of the video, or the like may be considered. In (1), a ratio occupied by the person in the video is used as the evaluation value by a function of detecting the personal area from the video. In (2), a ratio of a skin-colored area of the face occupied in the head portion area is used as the evaluation value by detecting the head portion.

In the above, the standard based on the imaging position and the standard based on the personal information are explained as the priority standard that orders a plurality of videos. In this case, the evaluating method such as the evaluation in which respective standards are combined with each other may be set freely.

Also, if the priority shown in the present embodiment is attached to the video and then a function of limiting the number of the displayed videos or a function of providing a lower limit of the evaluation value is provided, the video can be filtered and then displayed.

Also, the ordering result of the videos in the present embodiment can be reflected onto the size of the video display such that the video having the highest evaluation value is displayed large and the video having the low evaluation value is displayed small, and so forth.

As described above, in the present embodiment, since the function of ordering a plurality of vides constituting the multi-angle video based on the predetermined priority standard in construction is provided to the means for generating the multi-angle video from the base video and the related video, the videos can be aligned along the rule. Thus, such an effect can be achieved that the hard-to-see situation caused in monitoring a plurality of videos can be improved.

Also, since the videos are ordered by utilizing the desired evaluation value, the most desirable video can be easily acquired from the videos that meet the search key.

In this fashion, the monitoring in the present embodiment can attain such an effect that the monitoring of the video is improved to be seen easily, and attain a significant practical effect.

### Embodiment 5

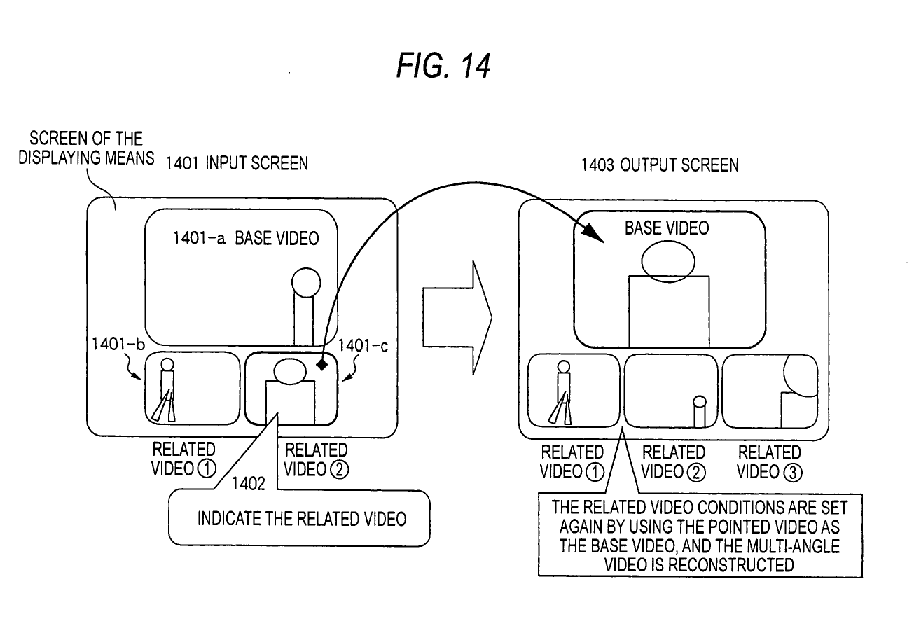

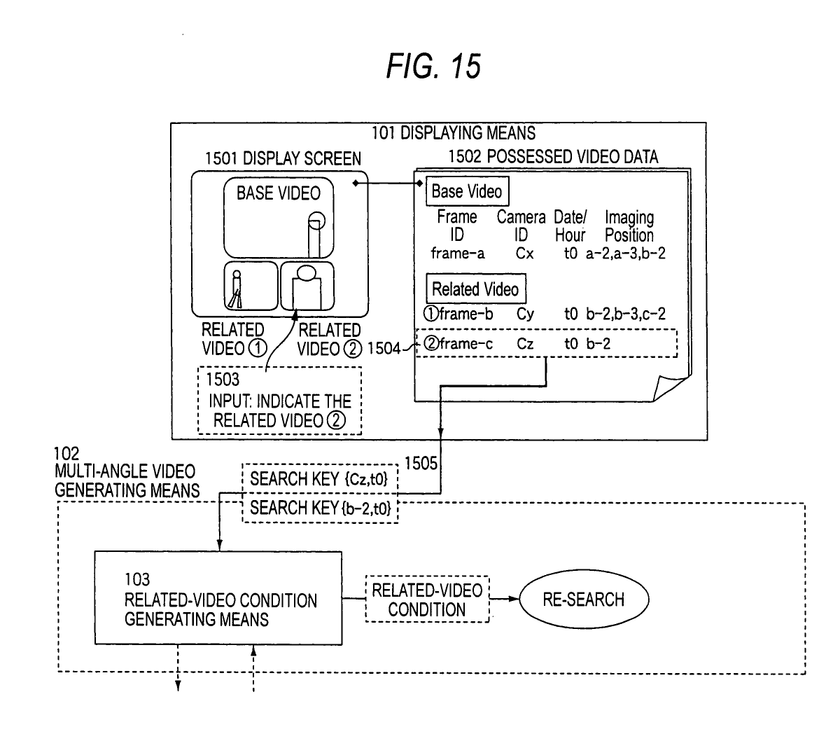

As an embodiment 5, a video generation processing apparatus having a means for switching the base video into any video being now displayed in the displaying means, on which the multi-angle video consisting of the base video and the related videos is displayed, and also having a function of reconstructing the multi-angle video of the new base video in response to the switching instruction will be explained with reference to FIG. 14 and FIG. 15 hereunder.

In this case, the invention shown in the embodiment 5 relates to the displaying/monitoring function of the multi-angle video consisting of the base video generated by the video generation processing apparatus shown in FIG. 1 and the related video, and is positioned as its expanded function. Therefore, this embodiment does not restrict the functions of respective means constituting the video generation processing apparatus, and can be implemented in any apparatus set forth in the above embodiments 1 to 4.

In the following explanation, a function of the displaying means associated with the present invention will be described mainly hereunder.

FIG. 14 shows an operational outline of the present embodiment.

An input screen 1401 shows a screen of the displaying means 101 on which the multi-angle video is displayed. The multi-angle video consists of the base video and the related video. In an example in FIG. 14, one base video 1401-a and a related video \mathring{1} 1401-b and a related video \mathring{2} 1401-c are displayed.

For such a reason that the object is shown larger in the related video \mathring{2} 1401-c than the base video 1401-a, for example, the desire “to watch mainly the related video \mathring{2} in detail” is caused in watching such multi-angle video. At this time, the user can instruct the displaying means 1401 to switch the video into the base video by pointing the related video \mathring{2} 1401-c via a click, or the like.

The present apparatus sets again the related video \mathring{2} 1401-c on the screen 1401 as the base video, and displays the multi-angle video consisting of the new base video and the related videos on an output screen 1403.

Processing flows in carrying out the operations shown in FIG. 14 are shown in FIG. 15.

In this case, since the video generation processing apparatus in the present embodiment has the similar configuration to that in FIG. 1, merely the displaying means 101 and the related-video condition generating means 103 serving as a part of the multi-angle video generating means 102, which are deeply concerned with the present embodiment 5, are shown in FIG. 15. Processing flows in other means are given as described in the explanation of the embodiments 1 to 3 respectively.

First, suppose that the multi-angle video consisting of one base video and two related videos \mathring{1}, \mathring{2} is displayed on the displaying means 101 (screen 1501). At this time, the displaying means 101 possesses information of frame ID, camera ID, date/hour, imaging position, etc. of each video as video data 1502 that are being displayed on the display screen 1501.

For example, the display means, when received an instruction 1503 to switch the related video \mathring{2} in the display screen to the base video from the user, searches video data 1504 of the pointed related video \mathring{2} from the possessed video data 1502. In FIG. 15, the pointed video is recognized as the video that was shot by a camera Cz at an imaging time t0 in an imaging position b-2. The displaying means 101 sets a search key {Cz,t0} consisting of the camera ID and the date/hour information or a search key {b-2,t0} consisting of the imaging position information and the date/hour information based on the data, and then sent out to the related-video condition generating means 103 (1505).

The related-video condition generating means 103, when received the search key, decides the related video condition by respective processes in the above embodiments 1 to 3 in response to the search key. Since subsequent processes are already explained in the above embodiments 1 to 3, their explanation will be omitted herein.

In this manner, in the present embodiment, the displaying means 101 has a function of managing always the video data displayed on its own display means, then setting again the search key based on the information of the pointed video data when change of the base video is instructed by the user, and then issuing the search key to the related video condition generating means 103. As the search key issued to the related video condition generating means 103, either the camera ID or the imaging position information can be employed. The multi-angle video generating means 102 executes the processes in answer to respective search keys, then generates the multi-angle video of the video that was pointed by the user, and then displays the video on the displaying means 101.

As described above, in the present embodiment, there is provided the video generation processing apparatus having the means for switching the base video into any video being now displayed upon monitoring the multi-angle video consisting of the base video and the related videos, and also having a function of reconstructing the multi-angle video of the new base video in response to the switching instruction. The high-level monitoring that is capable of changing the display video in response to the change of the noticeable video produced in monitoring the video can be realized.

In this way, the monitoring in the present embodiment can have an effect of improving the user interface, and have a significant practical effect.

### Embodiment 6

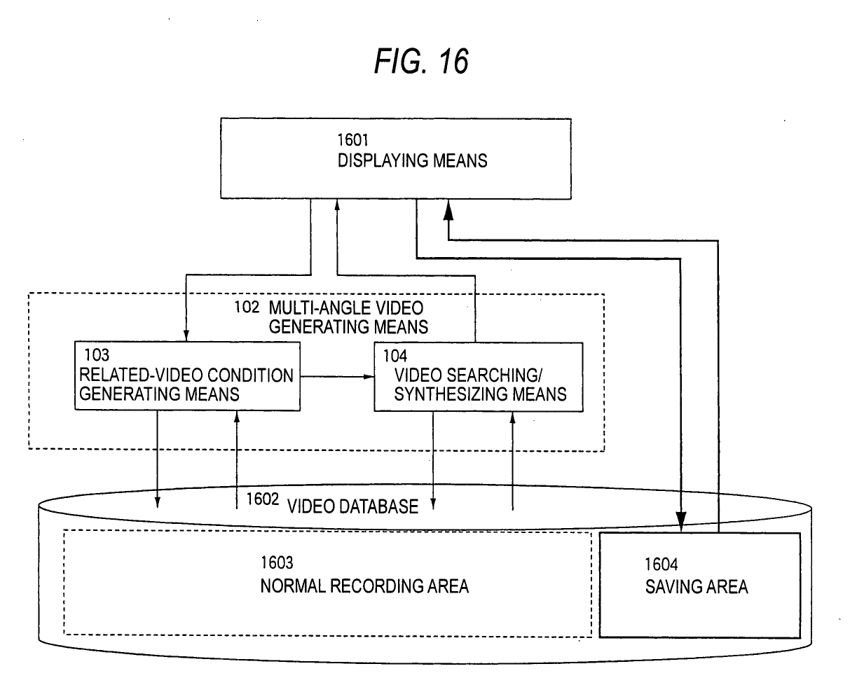

As an embodiment 6, a video generation processing apparatus having a function of packaging the multi-angle video displayed on the displaying means, i.e., a plurality of videos based on the user's instruction and then recording the packaged video in the video database, which has a recording area for accumulating desired videos (referred to as a “saving area” hereinafter) apart from a normal recording area for recording the imaging video of the monitor camera (referred to as a “normal recording area” hereinafter), will be explained with reference to FIG. 16 hereunder.

In this case, the invention shown in the embodiment 6 is positioned as an additional function of the video generation processing apparatus in FIG. 1. Therefore, this embodiment does not restrict the functions of respective means constituting the video generation processing apparatus, and can be implemented in any apparatus set forth in the above embodiments 1 to 3.

In the following explanation, displaying means and a video database associated with the present invention will be described mainly hereunder.

A configurative view of the video generation processing apparatus in the present embodiment is shown in FIG. 16.

In FIG. 16, 1601 denotes displaying means that has inputting means of indicating to save the multi-angle video being now displayed and a function of extracting the video from the data accumulated in a saving area 1604 of a video database 1602 described later to display, in addition to the functions of the displaying means 101 in FIG. 1.

Also, 1602 denotes a video database that consists of a normal recording area 1603 for recording the video data similarly to the video database 105 in FIG. 1, and a saving area 1604 capable of correlating a plurality of video data received from the displaying means 1601, then packaging these data, and then accumulating them therein.

In FIG. 16, the displaying means 1601, the multi-angle video generating means 102, the related-video condition generating means 103, the video searching/synthesizing means 104, and the normal recording area 1603 in the video database 1602 have a function of generating the multi-angle video by the operations described in the above embodiments 1 to 3 and then displaying the video on the displaying means 1601 respectively.

Upon displaying the multi-angle video on the displaying means 1601, this displaying means 1601 displays on the screen the inputting means that can indicate the saving of the multi-angle video on the display. For example, a “saving button”, or the like is displayed. When the “saving button” is clicked by the user, the displaying means 1601 sends out the data of the multi-angle video, which is being displayed in pressing the button, to the saving area 1604 in the video database 1602 and records the data therein. The multi-angle video consists of a plurality of videos, and the displaying means correlates respective video data, then makes packages of the videos, and then saves them. The “making packages” set forth herein means to handle a plurality of videos as one lump, and is realized by recording information, which indicate to go from one video to another video in the same lump, on the recording area. As the saved data, attribute information of respective videos and information about selection between the base video and the related video, the search key, etc. as well as respective video data are recorded.

In this case, upon viewing the video recorded in the saving area 1604, the videos can be searched by using each previously saved data and also the videos can be searched as either one packaged videos or individual video.

In the present embodiment, the function capable of making packages of the multi-angle video on the display and saving them is described. But the similar functions can be realized other than the video on the display. For example, a function capable of loading directly the multi-angle video, which is generated based on the pointed conditions, into the saving area on the video database and saving it therein by pointing the date/hour or the time interval and the camera ID or the imaging position information and instructing the saving of the video on the displaying means can also be realized.

As described above, in the present embodiment, the function capable of saving arbitrarily a plurality of videos having the relevancy constituting the multi-angle video by the user while holding their relevancy is provided. Therefore, such function permits the user to handle as a lump the related videos such as a group of videos showing the doubtful person from different angles, a plurality of videos showing the surroundings of the event on the occurrence of the event, and the like.

Also, according to this, in viewing the saved videos, the videos that meet the conditions can be monitored not individually but together with the related video.

In this manner, the monitoring in the present embodiment can have an effect capable of attaining the high-level perusing/saving and improving the user interface and an effect of improving the portability of the video data, and have a pronounced practical effect.

### Embodiment 7

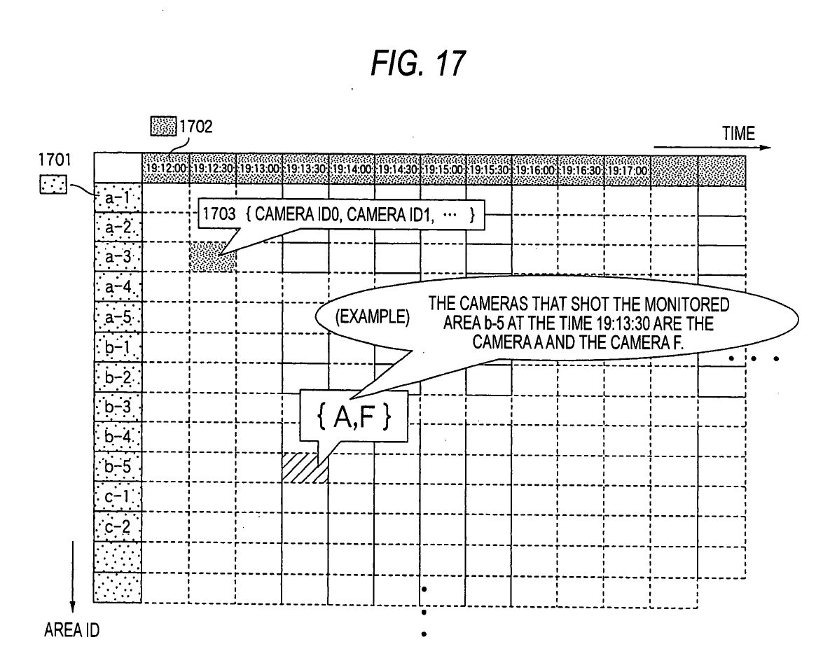

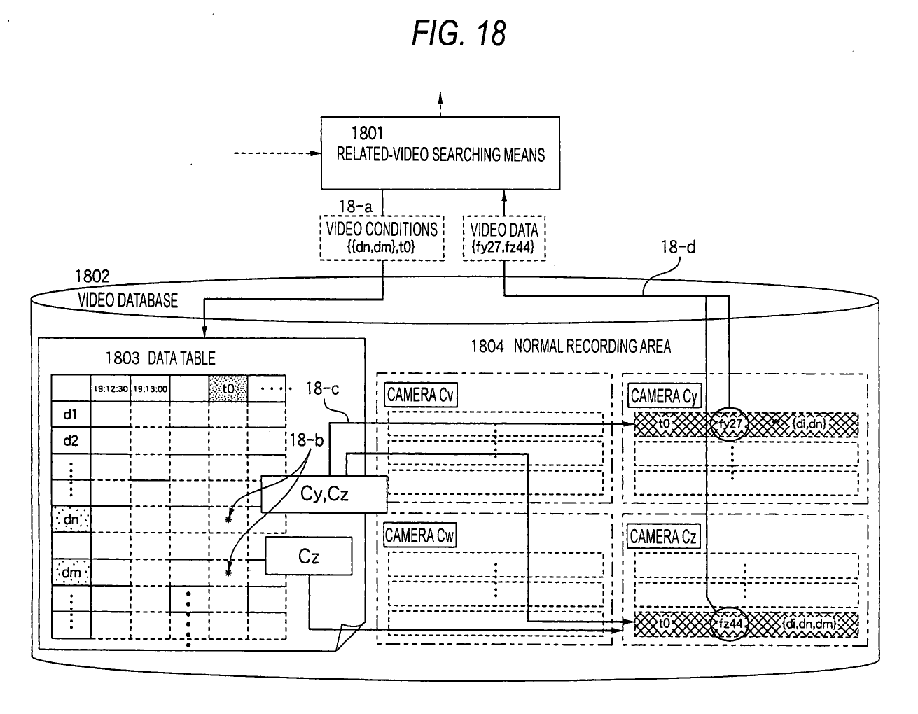

As an embodiment 7, a video generation processing apparatus that accelerates the video search based on three types of information by providing a means for managing integrally three types of information of imaging position, date/hour, and imaging camera about the videos accumulated in the video database by using a data table that can extract one type of remaining information from two types of any information will be explained with reference to FIG. 17 and FIG. 18 hereunder.

In this case, the invention shown in the embodiment 7 relates to the video database, and is positioned as an additional function of the video generation processing apparatus in FIG. 1. Therefore, this embodiment can be implemented in any apparatus set forth in the above embodiments 1 to 3, and this embodiment does not restrict the functions of other means constituting the video generation processing apparatus.

As an example of a recording structure used to manage the information of the imaging position, the date/hour, and the imaging camera, a data table for saving data 1703 consisting of a set of the camera IDs that shoot the area indicated by the first axis at the date/hour indicated by the second axis into cells, at which the first axis and the second axis intersect with each other, of a two-dimensional arrangement having the area ID of the imaging position on a first axis 1701 and the date/hour information on a second axis 1702 is shown in FIG. 17.

In this case, the data table shown in FIG. 17 can be generated by adding the camera ID to the cell that meets the information of the video data when the monitored video is recorded sequentially into the vide database. In this fashion, all the videos accumulated in the video database can be managed by recording the video data into the data table simultaneously with the normal recording of the video data, for example.

Next, a viewing process executed in the video generation processing apparatus having the normal recording area, in which the video data and the attribute information of the video data are recorded every camera, and the video database, which manages all the video information recorded in the normal recording area by using the data table shown in FIG. 17, will be explained hereunder.

Searching process flows executed when the imaging position information and the date/hour information are given as the searching conditions are shown in FIG. 18. In FIG. 18, only the related-video searching means and the video database serving as the main portions of the present process in the video generation processing apparatus are illustrated.

Step 18-a: Related video searching means 1801 accesses a video database 1802 by using a set {{dn,dm} of the area IDs indicating the imaging positions and the date/hour information t0 as the searching conditions.

Step 18-b: First, the related video searching means scans the cell that is adapted to a combination of each area ID and the date/hour information in the searching conditions from a data table 1803 in the video database 1802, and acquires the data recorded in the adapted cell. In FIG. 18, the related video searching means gets the set {Cy,Cz} of the camera ID as the information of the cell whose area ID is dn and whose date/hour is t0, and also gets the set {Cz} of the camera ID as the information of the cell whose area ID is dm and whose date/hour is t0. This signifies that two cameras showing the area dn at the date/hour t0 were Cy, Cz and also one camera showing the area dm at the date/hour t0 was Cz.

Step 18-c: Since the video adapted to the searching conditions {{dn,dm},t0} was picked up by the camera Cy and the camera Cz, the related video searching means searches the video data being picked up at the imaging time t0 from the normal recording area 1804 in which the video data of the cameras Cy, Cz are saved.

Step 18-d: The related video searching means acquires the video data found in Step 18-c.

In this manner, the process of searching the videos that satisfy the searching conditions from all the camera videos can be omitted by providing the data table 1803.

In this case, in the present embodiment, the data table in FIG. 17 is used to detect the camera that shot a predetermined position at a predetermined date/hour, by pointing the imaging position and the date/hour. But the data table may be utilized variously. For example, the searching to the effect that the user wishes to watch all the videos that show a certain imaging position on a certain day, or the like can be easily realized. In the conventional recording using only the normal recording area, the video showing the predetermined position must be searched every time from all the camera videos, by using a time 00:00:00 on the pointed day as an initial value of the date/hour information. However, the information indicating which camera shot the particular position at the particular time can be easily acquired by using the data table of the present invention.

In this case, in the present embodiment, the recording structure for managing the information of the imaging position, the date/hour, and the imaging camera is implemented by the two-dimensional arrangement. However, any mode may be employed to embody such structure if the imaging camera information can be uniquely referred to by two values of the imaging position and the date/hour.

As described above, in the present embodiment, since the means for managing integrally three types of information of the imaging position, and the date/hour, and the imaging camera about the videos accumulated in the video database by using a data table that can extract one type of remaining information from two types of any information is provided, such an effect of accelerating the video search based on three types of information can be achieved.

In particular, in the searching operation, which requires the full search in the conventional video recording, such that the user wishes to get the videos that show the particular area, the user wishes to get the videos that were shot at the particular date/hour, or the like, a processing speed can be largely improved.

In this way, the monitoring of the present embodiment has an effect of improving the search processing speed and has a significant practical effect.

This application was filed based on Japanese Patent Application (Patent Application No. 2002-193048) filed on Jul. 2, 2002 and the contents thereof are incorporated herein by the reference.

### INDUSTRIAL APPLICABILITY

As described above, according to the present invention, following advantages can be achieved.

First, since the function of generating the multi-angle video consisting of the base video pointed by the user and the video of other camera that shots the same spot as the base video as the related video is provided, the monitoring of the object shown by the particular camera from the multiple angles can be facilitated and also the high-security level monitoring to reduce the dead-angle areas can be carried out.

Second, since the function of generating the multi-angle video consisting of the base video pointed by the user and the video of other camera that shots the neighboring spots of the imaging point of the base video as the related video is provided, the checking of surrounding circumstances round the object shown by the particular camera can be facilitated and also the high-security level monitoring to reduce the dead-angle areas can be carried out.

Third, since the function of generating the multi-angle video consisting of the base video pointed by the user and the video of other camera that shots the invisible area of the base video as the related video is provided, the high-security level monitoring to reduce the dead-angle areas can be carried out.

Fourth, since the function of constructing the multi-angel video by ordering a plurality of videos constituting the multi-angel video according to the priority standard based on the imaging position information of respective videos is provided, the videos can be aligned in closer order to the imaging position of the user's desired video and also an effect of improving the hard-to-see situation generated upon viewing a plurality of videos can be achieved.

Fifth, since the function of constructing the multi-angel video by applying the personal detecting process to respective videos and then ordering a plurality of videos constituting the multi-angel video based on the personal information shown in respective videos is provided, the videos can be aligned in higher order of importance of the personal information that is important for the monitoring and also an effect of improving the hard-to-see situation generated upon viewing a plurality of videos can be achieved.

Sixth, since the means for switching the base video during monitoring the multi-angel video consisting of the base video and the related video is provided, the high-level monitoring that is capable of changing the displayed video in response to change of the noticeable video produced in watching the video can be achieved.

Seventh, since the means for saving a plurality of videos being displayed while leaving the relevancy as it is upon monitoring the multi-angel video is provided, a plurality of related videos can be handles as one lump.

Eighth, since the means for managing integrally three types of information of the imaging position, and the date/hour, and the imaging camera about the videos accumulated in the video database by using a data table that can extract one type of remaining information from two types of any information is provided, the searching speed of the video data that are characterized by the imaging position information or the date/hour information or the imaging camera or combinations of respective information can be improved.

1-12. (canceled)

13. A video generation processing apparatus comprising:
a plurality of imaging apparatus each for picking up a video;
video storing means for storing the videos picked up by the plurality of imaging apparatus and additional information of respective videos;
related-video condition generating means for generating related-video conditions that relates to base video from the video and an additional information stored in the video storing means; and
video acquiring means for acquiring related video that meets the related-video conditions from the video storing means,
wherein the videos picked up by the plurality of imaging apparatus are processed so as to display a plurality of videos which are related with each other and satisfy predetermined conditions.

14. The video generation processing apparatus according to claim 13, wherein the video generation processing apparatus acquires an imaging position information of the base video from video storing means by using first predetermined conditions that select the base video,
and generates the related-video conditions based on the acquired imaging position information and data/hour information contained in the first predetermined conditions.

15. The video generation processing apparatus according to claim 13, further comprising display processing means for processing the base video and the related video to display simultaneously on one screen.

16. The video generation processing apparatus according to claim 13, wherein an imaging apparatus for picking up the related video and an imaging apparatus for picking up the base video are different respectively.

17. The video generation processing apparatus according to claim 16, wherein the related-video conditions contain the imaging position information and the date/hour information.

18. The video generation processing apparatus according to claim 16, wherein the related-video conditions contain a position information of neighboring areas adjacent to a position indicated by the imaging position information and the date/hour information.

19. The video generation processing apparatus according to claim 16, wherein the related-video conditions contain a position information of invisible areas that are not picked up in the base video and the date/hour information.

20. The video generation processing apparatus according to claim 16, wherein the related-video condition generating means acquires imaging position information of video adjacent to the base video in a video feature space to generate the related-video conditions.

21. The video generation processing apparatus according to claim 16, wherein the related-video condition generating means acquires imaging position information of videos having a relevancy with the base video in meaning contents to generate the related video conditions.

22. The video generation processing apparatus according to claim 13, wherein respective videos are ordered in response to a priority rule when the related video contains at least two videos.

23. The video generation processing apparatus according to claim 13, wherein the additional information of respective videos stored in the video storing means contain imaging position information, date/hour information, and imaging apparatus information, and
a data structure of the video storing means is composed of a two-dimensional arrangement in which a first axis indicates the imaging position information and a second axis indicates the date/hour information and then information of the imaging apparatus that shot a predetermined imaging position at a predetermined date/hour are saved into a cell at which a predetermined imaging position information and a predetermined date/hour information intersect with each other.

24. A video generation processing method comprising:
picking up a video by a plurality of imaging apparatus;
storing the videos picked up by the plurality of imaging apparatus and additional information of respective videos in video storing means;
generating related-video conditions that relate to a base video from the video and an additional information stored in the video storing means;
acquiring a related video that meets the related-video conditions from the video storing means; and
processing the videos picked up by the plurality of imaging apparatus so as to display a plurality of videos which are related with each other and satisfy predetermined conditions.

25. The video storing apparatus for storing videos picked up by a plurality of imaging apparatus and additional information of respective videos,
wherein the additional information of respective videos contain imaging position information, date/hour information, and imaging apparatus information, and
a data structure of the video storing means is composed of a two-dimensional arrangement in which a first axis indicates the imaging position information and a second axis indicates the date/hour information and then information of the imaging apparatus that shot a predetermined imaging position at a predetermined date/hour are saved into a cell at which a predetermined imaging position information and a predetermined date/hour information intersect with each other.
